(19) United States
(12) Patent Application Publication
(10) Pub. No.: US 2002/0045700 A1
(43) Pub. Date: Apr. 18, 2002

(54) Non-magnetic composite particles for black toner and black toner using the same

(76) Inventors: Kazuyuki Hayashi, Hiroshima-shi (JP); Yusuke Shimohata, Hiroshima-shi (JP); Keisuke Iwasaki, Hiroshima-shi (JP); Hiroko Morii, Hiroshima-shi (JP)

Correspondence Address: NIXON & VANDERHYE P.C., 8th Floor, 1100 North Glebe Road, Arlington, VA, 22201, US

(21) Appl. No.: 09/902,801

(22) Filed: Sep. 4, 2001

(30) Foreign Application Priority Data
Jul. 14, 2000 (JP) 2000-215074
Jun. 1, 2001 (JP) 2001-167380

(51) Int. Cl. C08J 3/00

(52) U.S. Cl. 524/588

(57) ABSTRACT

Non-magnetic composite particles have an average particle diameter of 0.06 to 1.0 μm, and comprise:

hematite particles,

a coating formed on surface of said hematite particles, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on said coating layer comprising said organosilicon compound, in an amount of from 1 to 50 parts by weight based on 100 parts by weight of said hematite particles.

Such non-magnetic composite particles for black toner exhibiting not only a deep black color but also excellent fluidity and light resistance.

### BACKGROUND OF THE INVENTION:

The present invention relates to non-magnetic composite particles for black toner, and a black toner using the non-magnetic composite particles, and more particularly, to non-magnetic composite particles for black toner exhibiting not only a deep black color but also excellent fluidity and light resistance.

As recent image development systems, there have been mainly known one-component development system requiring no carrier, and two-component development system using both a black toner and a carrier. In the two-component development system, the black toner is brought into frictional contact with the carrier so as to apply thereto an electrostatic charge reverse in sign to that of an electrostatic latent image formed on a photosensitive member. As a result, the black toner is adhered onto the latent image by electrostatic attraction force so that the reverse-sign charge thereof is neutralized, thereby developing the latent image. As such a black toner, there have been extensively used composite particles obtained by mixing and dispersing a black pigment such as carbon black fine particles in resin.

In presently predominant PPC type copying machines, the black toner used in any development system has been required to show a good insulating property or a high resistivity. Specifically, the black toner has been required to have a volume resistivity of not less than 1×10¹³ Ω·cm.

Also, the black toner has been required to form linear and solid-area copy images having high blackness, i.e., a high density when developed therewith.

As to this fact, at page 272 of “Comprehensive Technical Data for Development and Utilization of Toner Materials” published by Nippon Science Information Co., Ltd., it is described that “although it is a feature of the powder behavior that the image density is high, the high image density considerably influences not only fog concentration but also image properties as described later”.

In addition, it is known that the behavior of developer in a developing device highly depends upon fluidity of the developer which further influences a frictional electrification property between black toner and carrier in the two-component development system or an electrification property of the black toner on a sleeve in the one-component development system. Therefore, with the recent tendency toward high image quality such as high image density and excellent tone gradation as well as high speed of developing devices, it has been strongly required to enhance the fluidity of the black toner.

In addition, with recent tendency toward reduction in particle size of the black toner, it has been more strongly required to improve the fluidity thereof.

As to this fact, at page 121 of the above “Comprehensive Technical Data for Development and Utilization of Toner Materials (1985)”, it is described that “Widespread printers such as IPC have been required to form high-quality printed images. In particular, it has been required to develop high-definition and high-accuracy printers. As is apparent from Table 1 showing a relationship between various toners and definitions of images obtained therefrom, the wet toner having a smaller particle size can form higher-definition images. Also, in order to enhance the definition of images obtained using a dry toner, the reduction in particle size of the toners is similarly required. . . . As to toners having a small particle size, it has been reported, for example, that the use of a toner having a particle size of 8.5 to 11 μm inhibits the generation of fog in background area and reduces the amount of toner consumed, and further the use of a polyester-based toner having a particle size of 6 to 10 μm results in high image quality, stable electrification property and prolonged service life of developer. However, such toners having a small particle size have many problems to be solved upon use, such as productivity, sharpness of particle size distribution, improvement in fluidity . . . or the like”.

In addition, since recording papers having printed images developed with the black toner are usually used or preserved for a long period of time after printing, the black toner is required to have an excellent light resistance in order to keep the clear printed images.

As described above, the black toner has been strongly required to be improved in various properties thereof. In particular, it is known that a black pigment exposed to the surface of the black toner considerably influences developing characteristics of the black toner. Thus, various properties of the black toner have a close relationship with those of the black pigment mixed and dispersed in the black toner.

Namely, since the degrees of blackness and density of the black toner largely varies depending upon those of the black pigment incorporated in the black toner, the black pigment itself has been strongly required to exhibit an excellent blackness. Also, the fluidity of the black toner largely varies depending on the surface conditions of the black pigment exposed to the surface of the black toner.

At present, carbon black fine particles have been mainly used as the black pigment incorporated in the black toner (Japanese Patent No. 2,715,336 and Japanese Patent Application Laid-Open (KOKAI) No. 10-39546(1998)).

However, in the case where the carbon black fine particles are used as non-magnetic composite particles for the black toner, the amount of the carbon black fine particles contained in the black toner must be limited to a certain low level, so that the obtained black toner fails to exhibit a sufficient volume resistivity as high as not less than 1×10¹³ Ω·cm. As a result, there arises such a problem that the black toner is insufficient in not only blackness but also fluidity.

These facts are explained more specifically below.

The carbon black fine particles themselves are conductive particles. When a large amount of the carbon black fine particles are added and mixed in order to enhance the blackness of the black toner, the carbon black fine particles are present on the surface of each toner particle while forming its structure. As a result, the black toner is deteriorated in volume resistivity value and, therefore, no longer usable as an insulating or high-resistant toner. On the other hand, when the amount of the carbon black fine particles used in the black toner is reduced in order to inhibit the black toner from being lowered in volume resistivity, the black toner is not only lowered in blackness, but also the carbon black fine particles are embedded within each black toner particle since the carbon black fine particles have an average particle size as fine as 0.010 to 0.060 μm. As a result, the amount of the carbon black fine particles exposed to the surface of each black toner particle is considerably reduced, so that the fluidity of the black toner tends to be deteriorated.

Further, the carbon black fine particles show a poor handling property since the specific gravity thereof is very low, i.e., from 1.80 to 1.85. Therefore, in the case where such carbon black fine particles are dispersed in a binder resin to prepare a black toner, the bulk density of the obtained black toner becomes low. Such a black toner tends to be readily scattered around and deteriorated in fluidity.

Thus, it has been required to provide non-magnetic particles having a sufficient blackness compatible with carbon black, which are usable as a black pigment incorporated in a black toner.

At present, it has been strongly required to provide non-magnetic composite particles for black toner exhibiting not only a more deep black color but also more excellent fluidity and light resistance. However, non-magnetic composite particles satisfying such properties have not been obtained conventionally.

As a result of the present inventors' earnest studies, it has been found that

by mixing hematite particles with at least one compound selected from the group consisting of:

(1) alkoxysilane compounds, and

(2) polysiloxanes or modified polysiloxanes, by using an apparatus capable of applying a shear force to the hematite particles, thereby coating the surface of the hematite particle with the said compounds; and

mixing the obtained hematite particles coated with the said compounds and an organic blue-based pigment in an amount of 1 to 50 parts by weight based on 100 parts by weight of the hematite particles by using an apparatus capable of applying a shear force to the hematite particles coated with the said compounds, thereby forming an organic blue-based pigment coat on the surface of a coating layer comprising the organosilicon compounds,

the obtained non-magnetic composite particles can exhibit not only a more deep black color, but also more excellent light resistance and fluidity. The present invention has been attained on the basis of the finding.

### SUMMARY OF THE INVENTION

An object of the present invention is to provide non-magnetic composite particles which are not only more excellent in fluidity, light resistance and deep black color, but also can show a more excellent dispersibility in a binder resin.

Another object of the present invention is to provide a black toner exhibiting not only a more deep black color but also more excellent fluidity and light resistance.

To accomplish the aims, in a first aspect of the present invention, there are provided non-magnetic composite particles having an average particle diameter of 0.06 to 1.0 μm, comprising:

hematite particles,

a coating formed on surface of said hematite particles, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on said coating layer comprising said organosilicon compound, in an amount of from 1 to 50 parts by weight based on 100 parts by weight of said hematite particles.

In a second aspect of the present invention, there are provided non-magnetic composite particles having an average particle diameter of 0.06 to 1.0 μm, comprising:

hematite particles having a coating formed on the surface of said hematite particle, comprising at least one organosilicon compound selected from the group consisting of:

(1) organosilane compounds obtainable from alkoxysilane compounds, and

(2) polysiloxanes or modified polysiloxanes, and

a carbon black coat formed on at least a part of the surface of said coating layer comprising said organosilicon compound, in an amount of 1 to 30 parts by weight based on 100 parts by weight of the said hematite particles;

a coating formed on the said carbon black coat, comprising at least one organosilicon compound selected from the group consisting of:

(1) organosilane compounds obtainable from alkoxysilane compounds, and

(2) polysiloxanes or modified polysiloxanes; and

an organic blue-based pigment coat formed on said coating layer comprising said organosilicon compound, in an amount of from 1 to 50 parts by weight based on 100 parts by weight of said hematite particles.

In a third aspect of the present invention, there are provided non-magnetic composite particles having an average particle diameter of 0.06 to 1.0 μm, comprising:

hematite particles having a coat formed on at least a part of the surface of said hematite particle and comprises at least one compound selected from the group consisting of hydroxides of aluminum, oxides of aluminum, hydroxides of silicon and oxides of silicon in an amount of 0.01 to 50% by weight, calculated as Al or SiO₂, based on the total weight of the hematite particles coated;

a coating formed on surface of said coat, comprising at least one organosilicon compound selected from the group consisting of:

(1) organosilane compounds obtainable from alkoxysilane compounds, and

(2) polysiloxanes or modified polysiloxanes; and

an organic blue-based pigment coat formed on said coating layer comprising said organosilicon compound, in an amount of from 1 to 50 parts by weight based on 100 parts by weight of said hematite particles.

In a fourth aspect of the present invention, there are provided non-magnetic composite particles having an average particle diameter of 0.06 to 1.0 μm, comprising:

hematite particles having a coat formed on at least a part of the surface of said hematite particle and comprises at least one compound selected from the group consisting of hydroxides of aluminum, oxides of aluminum, hydroxides of silicon and oxides of silicon in an amount of 0.01 to 50% by weight, calculated as Al or SiO₂, based on the total weight of the hematite particles coated,

a coating formed on the surface of said coat, comprising at least one organosilicon compound selected from the group consisting of:

(1) organosilane compounds obtainable from alkoxysilane compounds, and

(2) polysiloxanes or modified polysiloxanes, and

a carbon black coat formed on at least a part of the surface of said coating layer comprising said organosilicon compound, in an amount of 1 to 30 parts by weight based on 100 parts by weight of the said hematite particles;

a coating formed on the said carbon black coat, comprising at least one organosilicon compound selected from the group consisting of:

(1) organosilane compounds obtainable from alkoxysilane compounds, and

(2) polysiloxanes or modified polysiloxanes; and

an organic blue-based pigment coat formed on said coating layer comprising said organosilicon compound, in an amount of from 1 to 50 parts by weight based on 100 parts by weight of said hematite particles.

In a fifth aspect of the present invention, there is provided a process for producing said non-magnetic composite particles defined in claim 1, which process comprises:

mixing hematite particles together with at least one compound selected from the group consisting of:

(1) alkoxysilane compounds, and

(2) polysiloxanes or modified polysiloxanes, by using an apparatus capable of applying a shear force to the hematite particles, thereby coating the surface of said hematite particle with the said compounds;

mixing the obtained hematite particles coated with the said compounds and an organic blue-based pigments in an amount of 1 to 50 parts by weight based on 100 parts by weight of the hematite particles by using an apparatus capable of applying a shear force to the hematite particles coated with said compound, thereby forming an organic blue-based pigments coat on the surface of a coating layer comprising the organosilicon compounds.

In a sixth aspect of the present invention, there is provided a black toner comprising:

a binder resin, and

non-magnetic composite particles having an average particle diameter of 0.06 to 1.0 μm, comprising:

hematite particles,

a coating formed on surface of said hematite particles, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on said coating layer comprising said organosilicon compound, in an amount of from 1 to 50 parts by weight based on 100 parts by weight of said hematite particles.

In a seventh aspect of the present invention, there is provided a black toner comprising:

a binder resin, and

non-magnetic composite particles having an average particle diameter of 0.06 to 1.0 μm, comprising:

hematite particles having a coating formed on the surface of the said hematite particle, comprising at least one organosilicon compound selected from the group consisting of:

(1) organosilane compounds obtainable from alkoxysilane compounds, and

(2) polysiloxanes or modified polysiloxanes, and

a carbon black coat formed on at least a part of the surface of the said coating layer comprising the said organosilicon compound, in an amount of 1 to 30 parts by weight based on 100 parts by weight of the said hematite particles,

a coating formed on the said carbon black coat, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on said coating layer comprising said organosilicon compound, in an amount of from 1 to 50 parts by weight based on 100 parts by weight of said hematite particles.

In an eighth aspect of the present invention, there are provided non-magnetic composite particles comprising:

hematite particles,

a coating formed on surface of said hematite particles, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on said coating layer comprising said organosilicon compound, in an amount of from 1 to 50 parts by weight based on 100 parts by weight of said hematite particles; and

having an average particle diameter of 0.06 to 1.0 μm, a BET specific surface area value of 1.0 to 200 m²/g, a geometrical standard deviation of the particle size of 1.01 to 2.0, a L* value of 2.0 to 15.0, an a* value of −2.0 to 0.0, a b* value of −3.0 to 5.5.

In a ninth aspect of the present invention, there is provided a black toner comprising:

a binder resin, and non-magnetic composite particles having an average particle diameter of 0.06 to 1.0 μm, comprising:

hematite particles,

a coating formed on surface of said hematite particles, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on said coating layer comprising said organosilicon compound, in an amount of from 1 to 50 parts by weight based on 100 parts by weight of said hematite particles; and

having an average particle size of 3 to 25 μm, a flowability index of 70 to 100, a volume resistivity of not less than 1.0×10¹³ Ω·cm, a blackness (L* value) of 2.0 to 15.0, an a* value of −2.0 to 0.0, a b* value of −3.0 to 5.5, a light resistance (ΔE* value) of not more than 5.0.

### DETAILED DESCRIPTION OF THE INVENTION

The present invention is now described in detail below.

First, the non-magnetic composite particles according to the present invention are described.

The non-magnetic composite particles according to the present invention, comprise hematite particles as non-magnetic core particles having an average particle diameter of 0.055 to 0.98 μm, a coating layer comprising an organosilicon compound which is formed on the surface of each hematite particle, and an organic blue-based pigment adhered on a part of the coating layer.

As the non-magnetic core particles in the present invention, there may be exemplified hematite particles. In the consideration of blackness of the obtained non-magnetic composite particles, black hematite particles and black non-magnetic composite particles precursor using hematite particles as core particles are preferred.

As the black hematite particles (A), there may be exemplified manganese-containing hematite particles which contain manganese in an amount of 5 to 40% by weight, preferably 10 to 20% by weight (calculated as Mn) based on the weight of the manganese-containing hematite particles.

The black non-magnetic composite particles precursor (B) comprises the hematite particles, the organosilicon compound coating layer formed on the surface of each hematite particle, and the carbon black coat formed on the coating layer.

First, the hematite particles as non-magnetic core particles are described.

The hematite particles as the non-magnetic core particles may be isotropic particles having a ratio of an average major diameter to an average minor diameter (hereinafter referred to merely as “sphericity”) of usually not less than 1.0:1 and less than 2.0:1, such as spherical particles, granular particles or polyhedral particles, e.g., hexahedral particles or octahedral particles. In the consideration of the fluidity of the obtained non-magnetic composite particles, the spherical particles and granular particles are more preferred.

The hematite particles as the core particles have an average particle size of 0.055 to 0.98 μm preferably 0.065 to 0.78 μm, more preferably 0.065 to 0.48 μm.

When the average particle size of the hematite particles is more than 0.98 μm, the obtained non-magnetic composite particles are coarse particles and are deteriorated in tinting strength.

The hematite particles as the non-magnetic core particles have a sphericity of usually not less than 1.0:1 and less than 2.0:1, preferably 1.0:1 to 1.8:1, more preferably 1.0:1 to 1.6:1.

The hematite particles as the non-magnetic core particles have a geometrical standard deviation value of particle sizes of preferably not more than 2.0, more preferably not more than 1.8, still more preferably not more than 1.6. When the geometrical standard deviation value of the hematite particles is more than 2.0, coarse particles may be contained therein, so that the particles may be inhibited from being uniformly dispersed. As a result, it also may become difficult to uniformly coat the surfaces of the hematite particles with the alkoxysilanes or polysiloxanes, and uniformly adhere the organic blue-based pigment on the surface of the coating layer comprising the alkoxysilane or polysiloxanes. The lower limit of the geometrical standard deviation value is 1.01. It is industrially difficult to obtain particles having a geometrical standard deviation value of less than 1.01.

The BET specific surface area value of the hematite particles as the non-magnetic core particles is usually not less than 0.5 m²/g. When the BET specific surface area is less than 0.5 m²/g, the hematite particles may become coarse particles, or the sintering within or between the particles may be caused, so that the obtained non-magnetic composite particles may also become coarse particles and tend to be deteriorated in tinting strength. In the consideration of the tinting strength of the obtained non-magnetic composite particles, the BET specific surface area of the hematite particles is preferably not less than 1.0 m²/g, more preferably not less than 1.5 m²/g. Further, in the consideration of uniformly coating the surfaces of the hematite particles with the alkoxysilane or polysiloxanes, and uniformly adhering the organic blue-based pigment on the surface of the coating layer comprising the alkoxysilane or polysiloxanes, the upper limit of the BET specific surface area of the hematite particles is usually 200 m²/g, preferably 150 m²/g, more preferably 100 m²/g.

As to the fluidity of the hematite particles as the non-magnetic core particles, the fluidity index thereof is about 25 to about 42. Among the hematite particles having various shapes, the spherical hematite particles are more excellent in fluidity, for example, the fluidity index thereof is about 30 to about 42.

As to the hue of the hematite particles as the non-magnetic core particles, the lower limit of L* value thereof is 7.0, and the upper limit of the L* value is usually about 28.0, preferably about 26.0; the lower limit of a* value thereof is more than 0.0, and the upper limit of the a* value is usually about 17.0, preferably about 16.0; and the lower limit of b* value thereof is −1.0, and the upper limit of the b* value is usually about 13.0, preferably about 12.0. When the L* value exceeds 28.0, the lightness of the particles may be increased, so that it may be difficult to obtain non-magnetic composite particles having a sufficient blackness. When the a* value exceeds 17.0, the obtained particles may exhibit a reddish color, so that it may be difficult to obtain non-magnetic composite particles having a deep black color.

As to the light resistance of the hematite particles as the non-magnetic core particles, the lower limit of ΔE* value is more than 5.0, and the upper limit thereof is 12.0, preferably 10.0, when measured by the below-mentioned method.

The volume resistivity of the hematite particles, is usually not less than 1.0×10⁴ Ω·cm.

The hematite particle as non-magnetic core particle may be preliminarily coated with at least one compound selected from the group consisting of hydroxides of aluminum, oxides of aluminum, hydroxides of silicon and oxides of silicon (hereinafter referred to as “hydroxides and/or oxides of aluminum and/or silicon”), if required. The obtained hematite particles having a coating layer composed of hydroxides and/or oxides of aluminum and/or silicon can more effectively prevent the organic blue-based pigment adhered thereonto from being desorbed therefrom as compared to the case where the hematite particles are uncoated with hydroxides and/or oxides of aluminum and/or silicon.

The amount of the coating layer composed of hydroxides and/or oxides of aluminum and/or silicon is preferably 0.01 to 50% by weight (calculated as Al, SiO₂ or a sum of Al and SiO₂) based on the weight of the hematite particles coated.

When the amount of the coating layer composed of hydroxides and/or oxides of aluminum and/or silicon is less than 0.01% by weight, the effect of preventing the desorption of the organic blue-based pigment may not be obtained. When the amount of the coating layer composed of hydroxides and/or oxides of aluminum and/or silicon falls within the above-specified range of 0.01 to 50% by weight, the effect of preventing the desorption of the organic blue-based pigment can be sufficiently exhibited. Therefore, it is unnecessary and meaningless to form the coating layer composed of hydroxides and/or oxides of aluminum and/or silicon in such a large amount exceeding 50% by weight.

The particle size, geometrical standard deviation value, BET specific surface area value, volume resistivity value, fluidity, hue (L*, a* and b* values) and light resistance (ΔE* value) of the non-magnetic composite particles comprising the hematite particles having the coating layer composed of hydroxides and/or oxides of aluminum and/or silicon, are substantially the same as those of the non-magnetic composite particles comprising the hematite particles uncoated with the hydroxides and/or oxides of aluminum and/or silicon. The desorption percentage of the organic blue-based pigment from the non-magnetic composite particles can be reduced by forming the coating layer composed of hydroxides and/or oxides of aluminum and/or silicon on each hematite particle, and is preferably not more than 12%, more preferably not more than 10%.

Next, the black non-magnetic composite particles precursor (B) comprising hematite particles, an organosilicon compound coating layer formed on the surface of each hematite particle, and a carbon black coat formed on at least a part of the coating layer, is described below.

The black non-magnetic composite particles precursor comprise:

hematite particles having an average particle diameter of 0.050 to 0.95 μm;

a coating formed on the surface of the said hematite particles, comprising at least one organosilicon compound selected from the group consisting of:

(1) organosilane compounds obtainable from alkoxysilane compounds, and

(2) polysiloxanes or modified polysiloxanes, and

a carbon black coat formed on at least a part of the surface of the said coating layer comprising the said organosilicon compound, in an amount of 1 to 30 parts by weight based on 100 parts by weight of the said hematite particles.

The properties of the hematite particles used as the core particles of the black non-magnetic composite particles precursor are substantially the same as those of the hematite particles (A), except that the an average particle size of 0.050 to 0.95 μm, preferably 0.060 to 0.75 μm, more preferably 0.060 to 0.45 μm.

The coating formed on the surface of the hematite particle comprises at least one organosilicon compound selected from the group consisting of (1) organosilane compounds obtainable from alkoxysilane compounds; and (2) polysiloxanes and modified polysiloxanes selected from the group consisting of (2-A) polysiloxanes modified with at least one compound selected from the group consisting of polyethers, polyesters and epoxy compounds (hereinafter referred to merely as “modified polysiloxanes”), and (2-B) polysiloxanes whose molecular terminal is modified with at least one group selected from the group consisting of carboxylic acid groups, alcohol groups and a hydroxyl group (hereinafter referred to merely as “terminal-modified polysiloxanes”).

The organosilane compounds (1) may be produced from alkoxysilane compounds represented by the formula (I):

R¹ₐSiX₄₋ₐ (I)

wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

The drying or heat-treatment of the alkoxysilane compounds may be conducted, for example, at a temperature of usually 40 to 150° C., preferably 60 to 120° C. for usually 10 minutes to 12 hours, preferably 30 minutes to 3 hours.

Specific examples of the alkoxysilane compounds may include methyltriethoxysilane, dimethyldiethoxysilane, phenyltriethyoxysilane, diphenyldiethoxysilane, methyltrimethoxysilane, dimethyldimethoxysilane, phenyltrimethoxysilane, diphenyldimethoxysilane, isobutyltrimethoxysilane, decyltrimethoxysilane or the like. Among these alkoxysilane compounds, in view of the desorption percentage and the adhering effect of carbon black, methyltriethoxysilane, phenyltriethyoxysilane, methyltrimethoxysilane, dimethyldimethoxysilane and isobutyltrimethoxysilane are preferred, and methyltriethoxysilane and methyltrimethoxysilane are more preferred.

As the polysiloxanes (2), there may be used those compounds represented by the formula (II):

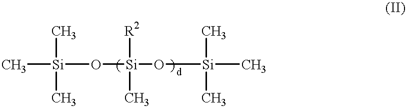

wherein R² is H— or CH₃—, and d is an integer of 15 to 450.

Among these polysiloxanes, in view of the desorption percentage and the adhering effect of the carbon black, polysiloxanes having methyl hydrogen siloxane units are preferred.

As the modified polysiloxanes (2-A), there may be used:

(a) polysiloxanes modified with polyethers represented by the formula (III):

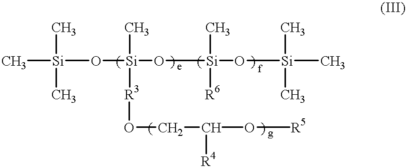

wherein R³ is —(—CH₂—)ₕ—; R⁴ is —(—CH₂—)ᵢ—CH₃; R⁵ is —OH, —COOH, —CH—CH₂, —C(CH₃)═CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300;

(b) polysiloxanes modified with polyesters represented by the formula (IV):

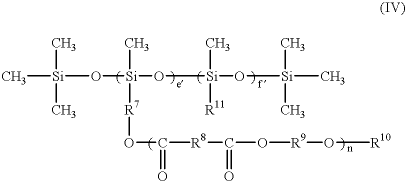

wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer of 1 to 15; r and s are an integer of 0 to 15; e′ is an integer of 1 to 50; and f′ is an integer of 1 to 300;

(c) polysiloxanes modified with epoxy compounds represented by the formula (V):

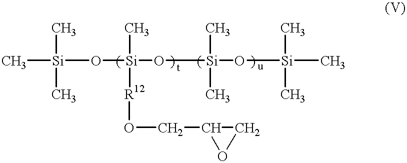

wherein R¹² is —(—CH₂—)ᵥ—; v is an integer of 1 to 15; t is an integer of 1 to 50; and u is an integer of 1 to 300; or a mixture thereof.

Among these modified polysiloxanes (2-A), in view of the desorption percentage and the adhering effect of the carbon black, the polysiloxanes modified with the polyethers represented by the formula (III), are preferred.

As the terminal-modified polysiloxanes (2-B), there may be used those represented by the formula (VI):

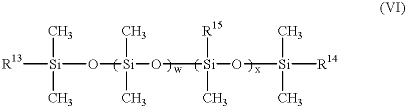

wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

Among these terminal-modified polysiloxanes, in view of the desorption percentage and the adhering effect of the carbon black, the polysiloxanes whose terminals are modified with carboxylic acid groups are preferred.

The coating amount of the organosilicon compounds is usually 0.02 to 5.0% by weight, preferably 0.03 to 4.0% by weight, more preferably 0.05 to 3.0% by weight (calculated as Si) based on the weight of the hematite particles coated with the organosilicon compounds.

When the coating amount of the organosilicon compounds is less than 0.02% by weight, it may be difficult to adhere the carbon black in a predetermined.

When the coating amount of the organosilicon compounds is more than 5.0% by weight, the carbon black can be adhered in a predetermined. Therefore, it is unnecessary and meaningless to coat the hematite particles with such a large amount of the organosilicon compounds.

The amount of the carbon black coat formed is 1 to 30 parts by weight based on 100 parts by weight of the hematite particles as core particles.

When the amount of the carbon black coat formed is less than 1 part by weight, the amount of the carbon black may be insufficient, so that it may become difficult to obtain black non-magnetic composite particles precursor having a sufficient fluidity and blackness.

On the other hand, when the amount of the carbon black coat formed is more than 30 parts by weight, the obtained black non-magnetic composite particles precursor can show a sufficient fluidity and blackness. However, since the amount of the carbon black is considerably large, the carbon black may tend to be desorbed from the coating layer composed of the organosilicon compound.

The thickness of carbon black coat formed is preferably not more than 0.04 μm, more preferably not more than 0.03 μm still more preferably not more than 0.02 μm. The lower limit thereof is more preferably 0.0001 μm.

The carbon black may be adhered either over a whole surface of the coating layer composed of the alkoxysilane or polysiloxanes, or on at least a part of the surface of the coating layer so as to expose a part of the coating layer composed of the alkoxysilane or polysiloxanes to the outer surface of each black non-magnetic composite particle precursor so that a carbon black coat is formed on the surface of the coating layer. Even though a part of the coating layer composed of the alkoxysilane or polysiloxanes is exposed to the outer surface of each black non-magnetic composite particle precursor, it is possible to suitably adhere the organic blue-based pigment thereonto.

The particle shape and particle size of the black non-magnetic composite particles precursor used in the present invention are considerably varied depending upon those of the hematite particles as core particles. The black non-magnetic composite particles precursor have a similar particle shape to that of the hematite particles as core particle, and a slightly larger particle size than that of the hematite particles as core particles.

More specifically, the black non-magnetic composite particles precursor (B) used in the present invention, have an average particle size of usually 0.055 to 0.98 μm, preferably 0.065 to 0.78 μm, more preferably 0.065 to 0.48 μm and a sphericity of usually not less than 1.0:1 and less than 2.0:1, preferably 1.0:1 to 1.8:1, more preferably 1.0:1 to 1.6:1.

When the average particle size of the hematite particles is more than 0.95 μm, the obtained non-magnetic composite particles may be coarse particle and deteriorated in tinting strength.

On the other hand, when the average particle size is too small, the agglomeration of the black non-magnetic composite particles precursor may tend to be caused. As a result, it may become difficult to uniformly coat the surface of the black non-magnetic composite particles precursor with the alkoxysilanes or polysiloxanes, and uniformly adhere the organic blue-based pigment on the surface of the coating layer comprising the alkoxysilanes or polysiloxanes.

The geometrical standard deviation value of the black non-magnetic composite particles precursor used in the present invention is preferably not more than 2.0, more preferably 1.01 to 1.8, still more preferably 1.01 to 1.6. The lower limit of the geometrical standard deviation value thereof is preferably 1.01. When the geometrical standard deviation value thereof is more than 2.0, it may become difficult to uniformly coat the surface of the black non-magnetic composite particles precursor with the alkoxysilanes or polysiloxanes, and uniformly adhere the organic blue-based pigment on the surface of the coating layer comprising the alkoxysilanes or polysiloxanes, because of the existence of coarse particles therein. It is industrially difficult to obtain such particles having a geometrical standard deviation of less than 1.01.

The BET specific surface area of the black non-magnetic composite particles precursor used in the present invention, is usually 0.5 to 200 m²/g, preferably 1.0 to 150 m²/g, more preferably 1.5 to 100 m²/g. When the BET specific surface area thereof is less than 0.5 m²/g, the obtained non-magnetic composite particles may be coarse, or the sintering within or between the black non-magnetic composite particles precursor may be caused, thereby deteriorating the tinting strength. On the other hand, when the BET specific surface area is more than 200 m²/g, the black non-magnetic composite particles precursor tends to be agglomerated together due to the reduction in particle size, so that it may become difficult to uniformly coat the surface of the black non-magnetic composite particles precursor with the alkoxysilanes or polysiloxanes, and uniformly adhere the organic blue-based pigment on the surface of the coating layer comprising the alkoxysilanes or polysiloxanes.

As to the fluidity of the black non-magnetic composite particles precursor used in the present invention, the fluidity index thereof is preferably 43 to 60, more preferably to 44 to 60.

As to the hue of the black non-magnetic composite particles precursor used in the present invention, the lower limit of L* value thereof is usually 2.7, and the upper limit of the L* value is usually 14.5, preferably 14.0; the lower limit of a* value thereof is usually 0.0, and the upper limit of the a* value is usually about 7.0, preferably about 6.0; and the lower limit of b* value thereof is usually −1.0, and the upper limit of the b* value is usually about 6.0, preferably about 5.0. When the L* value exceeds 14.5, the lightness of the particles may be increased, so that it may be difficult to obtain non-magnetic composite particles having a higher blackness. When the a* value exceeds 7.0, the obtained particles may exhibit a reddish color, so that it may be difficult to obtain non-magnetic composite particles having a deep black color.

As to the light resistance of the black hematite composite particles precursor, the ΔE* value is usually more than 4.0, when measured by the below-mentioned method. The upper limit of the ΔE* value thereof is preferably 12.0, more preferably 10.0, when measured by the below-mentioned method.

The desorption percentage of the carbon black from the black hematite composite particles precursor is preferably not more than 20% by weight, more preferably not more than 10% by weight (calculated as C).

In the black non-magnetic composite particles precursor used in the present invention, at least a part of the surface of the hematite particle may be preliminarily coated with at least one compound selected from the group consisting of hydroxides of aluminum, oxides of aluminum, hydroxides of silicon and oxides of silicon (hereinafter referred to as “hydroxides and/or oxides of aluminum and/or silicon coat”), if necessary. In this case, the obtained black non-magnetic composite particles precursor having a coating layer composed of hydroxides and/or oxides of aluminum and/or silicon, can more effectively prevent the organic blue-based pigment adhered thereonto from being desorbed therefrom as compared to the case where the black non-magnetic composite particles precursor wherein the hematite particles are uncoated with hydroxides and/or oxides of aluminum and/or silicon.

The amount of the hydroxides and/or oxides of aluminum and/or silicon coat is preferably 0.01 to 50% by weight (calculated as Al, SiO₂ or a sum of Al and SiO₂) based on the weight of the hematite particles coated.

When the amount of the hydroxides and/or oxides of aluminum and/or silicon coat is less than 0.01% by weight, the effect of preventing the desorption of the organic blue-based pigment may not be obtained.

On the other hand, when the amount of the hydroxides and/or oxides of aluminum and/or silicon falls within the above-specified range of 0.01 to 50% by weight, the effect of preventing the desorption of the organic blue-based pigment can be sufficiently exhibited. Therefore, it is unnecessary and meaningless to form the coating layer composed of hydroxides and/or oxides of aluminum and/or silicon in such a large amount exceeding 50% by weight.

The particle size, geometrical standard deviation, BET specific surface area, fluidity, hue (L*, a* and b* values), light resistance (ΔE* value) and non-magnetic properties of the black non-magnetic composite particles precursor, wherein the surface of the hematite particle is coated with the hydroxides and/or oxides of aluminum and/or silicon, are substantially the same as those of the black non-magnetic composite particles precursor wherein the hematite particle is uncoated with the hydroxides and/or oxides of aluminum and/or silicon.

The desorption percentage of the organic blue-based pigment can be reduced by forming the coating layer composed of hydroxides and/or oxides of aluminum and/or silicon thereon, and is preferably not more than 12%, more preferably not more than 10%.

The black non-magnetic composite particles precursor used in the present invention can be produced by the following method.

Among the isotropic hematite particles, the granular hematite particles can be produced by heating, in air at a temperature of 750 to 1,000° C., granular magnetite particles which are obtained by a so-called wet oxidation method, i.e., by passing an oxygen-containing gas through a suspension containing a ferrous hydroxide colloid obtained by reacting an aqueous ferrous salt solution with alkali hydroxide. (Refer to Japanese Patent Publication (KOKOKU) No. 44-668)

The granular manganese-containing hematite particles as the non-magnetic core particles used in the present invention, can be produced by heating, in air at a temperature of 750 to 1000° C., (a) coated magnetite particles which are obtained by first producing granular magnetite particles by a so-called wet oxidation method, i.e., by passing an oxygen-containing gas through a suspension containing a ferrous hydroxide colloid obtained by reacting an aqueous ferrous salt solution with alkali hydroxide, and then coating the obtained granular magnetite particles with a manganese compound in an amount of 8 to 150 atm % (calculated as Mn) based on whole Fe, or (b) magnetite particles containing manganese in an amount of 8 to 150 atm % (calculated as Mn) based on whole Fe, which are obtained by conducting the above wet oxidation method in the presence of manganese. In the consideration of blackness of the obtained manganese-containing hematite particles, it is preferred to use the manganese-containing magnetite particles (b). (Refer to Japanese Patent Application Laid-open (KOKAI) No. 4-144924)

The coating of the hematite particles with the alkoxysilane compounds, the polysiloxanes, the modified polysiloxanes or the terminal-modified polysiloxanes, may be conducted (i) by mechanically mixing and stirring the hematite particles together with the alkoxysilane compounds, the polysiloxanes, the modified polysiloxanes or the terminal-modified polysiloxanes; or (ii) by mechanically mixing and stirring both the components together while spraying the alkoxysilane compounds, the polysiloxanes, the modified polysiloxanes or the terminal-modified polysiloxanes onto the hematite particles. In these cases, substantially whole amount of the alkoxysilane compounds, the polysiloxanes, the modified polysiloxanes or the terminal-modified polysiloxanes added can be applied onto the surfaces of the hematite particles.

In order to uniformly coat the surfaces of the hematite particles with the alkoxysilane compounds, the polysiloxanes, the modified polysiloxanes or the terminal-modified polysiloxanes, it is preferred that the hematite particles are preliminarily diaggregated by using a pulverizer.

As apparatus (a) for mixing and stirring the hematite particles with the alkoxysilane compounds, the polysiloxanes, the modified polysiloxanes or the terminal-modified polysiloxanes to form the coating layer thereof, and (b) for mixing and stirring carbon black fine particles with the particles whose surfaces are coated with the alkoxysilane compounds, the polysiloxanes, the modified polysiloxanes or the terminal-modified polysiloxanes to form the carbon black coat, there may be preferably used those apparatus capable of applying a shear force to the particles, more preferably those apparatuses capable of conducting the application of shear force, spatulate-force and compressed-force at the same time. In addition, by conducting the above mixing or stirring treatment (a) of the core particles together with the alkoxysilane compounds, the polysiloxanes, the modified polysiloxanes or the terminal-modified polysiloxanes, at least a part of the alkoxysilane compounds coated on the hematite particles may be changed to the organosilane compounds.

As such apparatuses, there may be exemplified wheel-type kneaders, ball-type kneaders, blade-type kneaders, roll-type kneaders or the like. Among them, wheel-type kneaders are preferred.

Specific examples of the wheel-type kneaders may include an edge runner (equal to a mix muller, a Simpson mill or a sand mill), a multi-mull, a Stotz mill, a wet pan mill, a Conner mill, a ring muller, or the like. Among them, an edge runner, a multi-mull, a Stotz mill, a wet pan mill and a ring muller are preferred, and an edge runner is more preferred.

Specific examples of the ball-type kneaders may include a vibrating mill or the like. Specific examples of the blade-type kneaders may include a Henschel mixer, a planetary mixer, a Nawter mixer or the like. Specific examples of the roll-type kneaders may include an extruder or the like.

In order to coat the surfaces of the hematite particles with the alkoxysilane compounds, the polysiloxanes, the modified polysiloxanes or the terminal-modified polysiloxanes as uniformly as possible, the conditions of the above mixing or stirring treatment may be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 to 120 minutes, preferably 10 to 90 minutes. It is preferred to appropriately adjust the stirring speed in the range of usually 2 to 2,000 rpm preferably 5 to 1,000 rpm more preferably 10 to 800 rpm.

The amount of the alkoxysilane compounds, the polysiloxanes, the modified polysiloxanes or the terminal-modified polysiloxanes added, is preferably 0.15 to 45 parts by weight based on 100 parts by weight of the hematite particles. When the amount of the alkoxysilane compounds, the polysiloxanes, the modified polysiloxanes or the terminal-modified polysiloxanes added is less than 0.15 part by weight, it may become difficult to form the carbon black coat in such an amount enough to improve the blackness and flowability of the obtained black non-magnetic composite particles precursor.

On the other hand, when the amount of the alkoxysilane compounds, the polysiloxanes, the modified polysiloxanes or the terminal-modified polysiloxanes added is more than 45 parts by weight, a sufficient amount of the carbon black coat can be formed on the surface of the coating, but it is meaningless because the blackness and flowability of the obtained black non-magnetic composite particles precursor cannot be further improved by using such an excess amount of the alkoxysilane compounds, the polysiloxanes, the modified polysiloxanes or the terminal-modified polysiloxanes added.

Next, the carbon black fine particles are added to the hematite particles coated with the alkoxysilane compounds, the polysiloxanes, the modified polysiloxanes or the terminal-modified polysiloxanes, and the resultant mixture is mixed and stirred to form the carbon black coat on the surfaces of the coating composed of the alkoxysilane compounds, the polysiloxanes, the modified polysiloxanes or the terminal-modified polysiloxanes added. In addition, by conducting the above mixing or stirring treatment (b) of the carbon black fine particles together with the hematite particles coated with the alkoxysilane compounds, the polysiloxanes or the modified polysiloxanes, the terminal-modified polysiloxanes, at least a part of the alkoxysilane compounds coated on the hematite particles may be changed to the organosilane compounds.

In the case where the alkoxysilane compounds are used as the coating compound, after the carbon black coat is formed on the surface of the coating layer, the resultant composite particles may be dried or heat-treated, for example, at a temperature of usually 40 to 150° C., preferably 60 to 120° C. for usually 10 minutes to 12 hours, preferably 30 minutes to 3 hours, thereby forming a coating layer composed of the organosilane compounds (1).

It is preferred that the carbon black fine particles are added little by little and slowly, especially about 5 to 60 minutes.

In order to form carbon black onto the coating layer composed of the alkoxysilane compounds, the polysiloxanes, the modified polysiloxanes or the terminal-modified polysiloxanes as uniformly as possible, the conditions of the above mixing or stirring treatment can be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 to 120 minutes, preferably 10 to 90 minutes. It is preferred to appropriately adjust the stirring speed in the range of usually 2 to 2,000 rpm preferably 5 to 1,000 rpm more preferably 10 to 800 rpm.

The amount of the carbon black fine particles added, is preferably 1 to 30 parts by weight based on 100 parts by weight of the hematite particles. When the amount of the carbon black fine particles added is less than 1 part by weight, it may become difficult to form the carbon black coat in such an amount enough to improve the blackness and flowability of the obtained black non-magnetic composite particles precursor. On the other hand, when the amount of the carbon black fine particles added is more than 30 parts by weight, a sufficient blackness and flowability of the resultant black non-magnetic composite particles precursor can be obtained, but the carbon black tend to be desorbed from the surface of the coating layer because of too large amount of the carbon black adhered, so that it may become difficult to uniformly coat the surface of the black non-magnetic composite particles precursor with the alkoxysilanes or polysiloxanes, and uniformly adhere the organic blue-based pigment on the surface of the coating layer comprising the alkoxysilanes or polysiloxanes.

At least a part of the surface of the hematite particles may be coated with at least one compound selected from the group consisting of hydroxides of aluminum, oxides of aluminum, hydroxides of silicon and oxides of silicon, if required.

The coat of the hydroxides and/or oxides of aluminum and/or silicon may be conducted by adding an aluminum compound, a silicon compound or both the compounds to a water suspension in which the hematite particles are dispersed, followed by mixing and stirring, and further adjusting the pH value of the suspension, if required, thereby coating the surfaces of the hematite particles with at least one compound selected from the group consisting of hydroxides of aluminum, oxides of aluminum, hydroxides of silicon and oxides of silicon. The thus obtained hematite particles coated with the hydroxides and/or oxides of aluminum and/or silicon are then filtered out, washed with water, dried and pulverized. Further, the hematite particles coated with the hydroxides and/or oxides of aluminum and/or silicon may be subjected to post-treatments such as deaeration treatment and compaction treatment, if required.

As the aluminum compounds, there may be exemplified aluminum salts such as aluminum acetate, aluminum sulfate, aluminum chloride or aluminum nitrate, alkali aluminates such as sodium aluminate or the like.

The amount of the aluminum compound added is 0.01 to 50% by weight (calculated as Al) based on the weight of the hematite particles.

As the silicon compounds, there may be exemplified water glass #3, sodium orthosilicate, sodium metasilicate or the like.

The amount of the silicon compound added is 0.01 to 50% by weight (calculated as SiO₂) based on the weight of the hematite particles.

In the case where both the aluminum and silicon compounds are used in combination for the coating, the total amount of the aluminum and silicon compounds added is preferably 0.01 to 50% by weight (calculated as a sum of Al and SiO₂) based on the weight of the hematite particles.

Next, the non-magnetic composite particles according to the present invention are explained.

In the case where isotropic particles are used as non-magnetic core particles of the non-magnetic composite particles, the average particle size of the non-magnetic composite particles is usually 0.06 to 1.0 μm; and the sphericity thereof is usually not less than 1.0:1 and less than 2.0:1; the geometrical standard deviation value of particle sizes thereof is usually 1.01 to 2.0; the BET specific surface area value thereof is usually 1.0 to 200 m²/g; the fluidity index thereof is usually 44 to 80; the L* value thereof is usually 2.0 to 15.0; the a* value thereof is usually −2.0 to 0.0; the b* value thereof is usually −3.0 to 5.5; the light resistance (ΔE* value) thereof is usually not more than 5.0; the desorption percentage of the organic blue-based pigment therefrom is usually not more than 15%; the volume resistivity value thereof is usually not less than 5.0×10⁵ Ω·cm.

The particle shape and particle size of the non-magnetic composite particles largely varies depending upon those of the non-magnetic core particles such as the hematite particles (A) and the black non-magnetic composite particles precursor (B). The particle configuration or structure of the non-magnetic composite particles is usually similar to that of the non-magnetic core particles.

More specifically, in the case where the hematite particles (A) having an isotropic shape are used as non-magnetic core particles of the non-magnetic composite particles, the average particle size of the non-magnetic composite particles is usually 0.06 to 1.0 μm, preferably 0.07 to 0.8 μm, more preferably 0.07 to 0.5 μm; and the sphericity thereof is usually not less than 1.0:1 and less than 2.0:1, more preferably 1.0:1 to 1.8:1, still more preferably 1.0:1 to 1.6:1.

When the average particle size of the non-magnetic composite particles is more than 1.0 μm, the obtained particles may be coarse particles and may be deteriorated in tinting strength. On the other hand, when the average particle size is less than 0.06 μm, the particle size thereof becomes smaller, so that agglomeration of the particles may tend to be caused, resulting in poor dispersibility in binder resin upon the production of black toner.

In the case where the hematite particles (A) are used as non-magnetic core particles of the non-magnetic composite particles, the geometrical standard deviation value of particle sizes of the non-magnetic composite particles is preferably not more than 2.0, and the lower limit of the geometrical standard deviation value is preferably 1.01, more preferably 1.01 to 1.8, still more preferably 1.01 to 1.6. When the geometrical standard deviation value of the non-magnetic composite particles is more than 2.0, coarse particles may be contained therein, so that the non-magnetic composite particles may tend to be deteriorated in tinting strength. It is industrially difficult to obtain particles having a geometrical standard deviation value of less than 1.01.

In the case where the hematite particles (A) are used as non-magnetic core particles of the non-magnetic composite particles, the BET specific surface area value of the non-magnetic composite particles is usually 1.0 to 200 m²/g, preferably 1.5 to 150 m²/g, more preferably 2.0 to 100 m²/g. When the BET specific surface area value is less than 1.0 m²/g, the non-magnetic composite particles may become coarse particles, or the sintering within or between the particles may be caused, so that the obtained particles tend to be deteriorated in tinting strength. When the BET specific surface area value is more than 200 m²/g, the particle size thereof becomes smaller, so that agglomeration of the particles may tend to be caused, resulting in poor dispersibility in binder resin upon the production of black toner.

In the case where the hematite particles (A) are used as non-magnetic core particles of the non-magnetic composite particles, as to the fluidity of the non-magnetic composite particles, the fluidity index thereof is preferably 44 to 80, more preferably 45 to 80, still more preferably 46 to 80. When the fluidity index of the non-magnetic composite particles is less than 44, the fluidity of the non-magnetic composite particles may tend to become insufficient, thereby failing to improve the fluidity of the finally obtained black toner. Further, in the production process of the black toner, there may tend to be caused defects such as clogging of hopper, etc., thereby deteriorating the handling property or workability.

In the case where the hematite particles (A) are used as non-magnetic core particles of the non-magnetic composite particles, as to the hue of the non-magnetic composite particles, the lower limit of L* value thereof is usually 3.0, and the upper limit of the L* value is usually 15.0, preferably 13.5, more preferably 11.0; the lower limit of a* value thereof is usually −2.0, and the upper limit of the a* value is usually 0.0, preferably −0.1, more preferably −0.2; and the lower limit of b* value thereof is usually −3.0, and the upper limit of the b* value is usually 5.5, preferably 5.0. When the L* value exceeds 15.0, the lightness of the particles may be increased, so that it may be difficult to say that the blackness of the non-magnetic composite particles is excellent. When the a* value exceeds 0.0, the obtained particles may exhibit a reddish color, so that it may be difficult to obtain non-magnetic composite particles having a deep black color.

In the case where the hematite particles (A) are used as non-magnetic core particles of the non-magnetic composite particles, as to the light resistance of the non-magnetic composite particles, the ΔE* value thereof is usually not more than 5.0, preferably not more than 4.0, when measured by the below-mentioned method.

In the case where the hematite particles (A) are used as non-magnetic core particles of the non-magnetic composite particles, the volume resistivity value of the non-magnetic composite particles is usually not less than 5.0×10⁵ Ω·cm, preferably 1.0×10⁶ to 5.0×10⁸ Ω·cm, more preferably 3.0×10⁶ to 5.0×10⁸ Ω·cm. When the volume resistivity value is less than 5.0×10⁵ Ω·cm, the obtained black toner may be also deteriorated in volume resistivity.

In the case where the hematite particles (A) are used as non-magnetic core particles of the non-magnetic composite particles, the dispersibility of the non-magnetic composite particles in binder resin is preferably Rank 4 or Rank 5, more preferably Rank 5 when evaluated by the below-mentioned dispersibility evaluation method.

In the case where the hematite particles (A) are used as non-magnetic core particles of the non-magnetic composite particles, the desorption percentage of the organic blue-based pigment from the non-magnetic composite particles is preferably not more than 15%, more preferably not more than 12%. When the desorption percentage of the organic blue-based pigment is more than 15%, uniform dispersion of the obtained non-magnetic composite particles may tend to be inhibited by the desorbed organic blue-based pigment, and further it may become difficult to obtain non-magnetic composite particles having a uniform hue, because the hue of the non-magnetic core particles is exposed to the outer surface of each non-magnetic composite particle.

In particular, the properties of the non-magnetic composite particles produced using the black non-magnetic composite particles precursor (B) as non-magnetic core particles, are described below.

In the case where the black non-magnetic composite particles precursor (B) having isotropic particles are used as non-magnetic core particles of the non-magnetic composite particles, the average particle size of the non-magnetic composite particles is usually 0.06 to 1.0 μm, preferably 0.07 to 0.8 μm, more preferably 0.07 to 0.5 μm; and the sphericity thereof is usually not less than 1.0:1 and less than 2.0:1, preferably 1.0:1 to 1.8:1, more preferably 1.0:1 to 1.6:1.

In the case where the black non-magnetic composite particles precursor (B) is used as non-magnetic core particles of the non-magnetic composite particles, the geometrical standard deviation value of particle sizes of the non-magnetic composite particles is preferably not more than 2.0, and the lower limit of the geometrical standard deviation value is preferably 1.01, more preferably 1.01 to 1.8, still more preferably 1.01 to 1.6.

In the case where the black non-magnetic composite particles precursor (B) is used as non-magnetic core particles of the non-magnetic composite particles, the BET specific surface area value of the non-magnetic composite particles is usually 1.0 to 200 m²/g, preferably 1.5 to 150 m²/g, more preferably 2.0 to 100 m²/g.

In the case where the black non-magnetic composite particles precursor (B) is used as non-magnetic core particles of the non-magnetic composite particles, as to the fluidity of the non-magnetic composite particles, the fluidity index thereof is preferably 44 to 80, more preferably 45 to 80, still more preferably 46 to 80.

In the case where the black non-magnetic composite particles precursor (B) is used as non-magnetic core particles of the non-magnetic composite particles, as to the hue of the non-magnetic composite particles, the lower limit of L* value thereof is usually 2.0, and the upper limit of the L* value is usually 11.0, preferably 10.0, more preferably 8.5; the lower limit of a* value thereof is usually −2.0, and the upper limit of the a* value is usually 0.0, preferably −0.1, more preferably −0.2; and the lower limit of b* value thereof is usually −3.0, and the upper limit of the b* value is usually 5.5, preferably 5.0.

In the case where the black non-magnetic composite particles precursor (B) is used as non-magnetic core particles of the non-magnetic composite particles, as to the light resistance of the non-magnetic composite particles, the ΔE* value thereof is usually not more than 5.0, preferably not more than 4.0, when measured by the below-mentioned method.

In the case where the black non-magnetic composite particles precursor (B) is used as non-magnetic core particles of the non-magnetic composite particles, the volume resistivity value of the non-magnetic composite particles is usually not less than 5.0×10⁵ Ω·cm, preferably 1.0×10⁶ to 1.0×10⁸ Ω·cm.

In the case where the black non-magnetic composite particles precursor (B) is used as non-magnetic core particles of the non-magnetic composite particles, the dispersibility of the non-magnetic composite particles in binder resin is preferably Rank 4 or Rank 5, more preferably Rank 5 when evaluated by the below-mentioned dispersibility evaluation method.

In the case where the black non-magnetic composite particles precursor (B) is used as non-magnetic core particles of the non-magnetic composite particles, the desorption percentage of the organic blue-based pigment from the non-magnetic composite particles is preferably not more than 15%, more preferably not more than 12%.

The coating formed on the surface of the non-magnetic core particle such as hematite particles (A) or black non-magnetic composite particles precursor (B), comprises at least one organosilicon compound selected from the group consisting of (1) organosilane compounds obtainable from alkoxysilane compounds; and (2) polysiloxanes and modified polysiloxanes selected from the group consisting of (2-A) polysiloxanes modified with at least one compound selected from the group consisting of polyethers, polyesters and epoxy compounds (hereinafter referred to merely as “modified polysiloxanes”), and (2-B) polysiloxanes whose molecular terminal is modified with at least one group selected from the group consisting of carboxylic acid groups, alcohol groups and a hydroxyl group.

The organosilane compounds (1) may be produced by drying or heat-treating alkoxysilane compounds represented by the formula (I):

R¹ₐSiX₄₋ₐ (I)

wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

The drying or heat-treatment of the alkoxysilane compounds may be conducted, for example, at a temperature of usually 40 to 150° C., preferably 60 to 120° C. for usually 10 minutes to 12 hours, preferably 30 minutes to 3 hours.

Specific examples of the alkoxysilane compounds may include methyltriethoxysilane, dimethyldiethoxysilane, phenyltriethyoxysilane, diphenyldiethoxysilane, methyltrimethoxysilane, dimethyldimethoxysilane, phenyltrimethoxysilane, diphenyldimethoxysilane, isobutyltrimethoxysilane, decyltrimethoxysilane or the like. Among these alkoxysilane compounds, in view of the desorption percentage and the adhering effect of organic blue-based pigments, methyltriethoxysilane, phenyltriethyoxysilane, methyltrimethoxysilane, dimethyldimethoxysilane and isobutyltrimethoxysilane are preferred, and methyltriethoxysilane and methyltrimethoxysilane are more preferred.

As the polysiloxanes (2), there may be used those compounds represented by the formula (II):

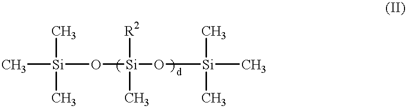

wherein R² is H— or CH₃—, and d is an integer of 15 to 450.

Among these polysiloxanes, in view of the desorption percentage and the adhering effect of the organic blue-based pigments, polysiloxanes having methyl hydrogen siloxane units are preferred.

As the modified polysiloxanes (2-A), there may be used:

(a) polysiloxanes modified with polyethers represented by the formula (III):

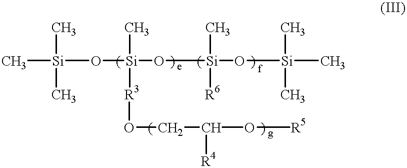

wherein R³ is —(—CH₂—)ₕ—; R⁴ is —(—CH₂—)ᵢ—CH₃; R⁵ is —OH, —COOH, —CH═CH₂, —C(CH₃)—CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300;

(b) polysiloxanes modified with polyesters represented by the formula (IV):

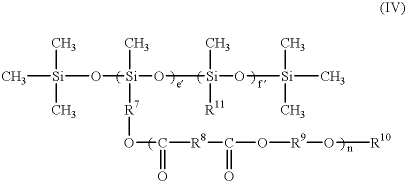

wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer of 1 to 15; r and s are an integer of 0 to 15; e′ is an integer of 1 to 50; and f′ is an integer of 1 to 300;

(c) polysiloxanes modified with epoxy compounds represented by the formula (V):

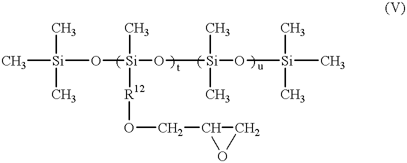

wherein R¹² is —(—CH₂—)ᵥ—; v is an integer of 1 to 15; t is an integer of 1 to 50; and u is an integer of 1 to 300; or a mixture thereof.

Among these modified polysiloxanes (2-A), in view of the desorption percentage and the adhering effect of the organic blue-based pigments, the polysiloxanes modified with the polyethers represented by the formula (III), are preferred.

As the terminal-modified polysiloxanes (2-B), there may be used those represented by the formula (VI):

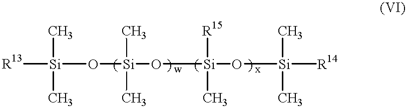

wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

Among these terminal-modified polysiloxanes, in view of the desorption percentage and the adhering effect of the organic blue-based pigments, the polysiloxanes whose terminals are modified with carboxylic acid groups are preferred.

The coating amount of the organosilicon compounds is usually 0.02 to 5.0% by weight, preferably 0.03 to 4.0% by weight, more preferably 0.05 to 3.0% by weight (calculated as Si) based on the weight of the non-magnetic core particles coated with the organosilicon compounds.

When the coating amount of the organosilicon compounds is less than 0.02% by weight, it may be difficult to adhere the organic blue-based pigments in a predetermined.

When the coating amount of the organosilicon compounds is more than 5.0% by weight, the organic blue-based pigments can be adhered in a predetermined. Therefore, it is unnecessary and meaningless to coat the non-magnetic core particles with such a large amount of the organosilicon compounds.

As the organic blue-based pigments used in the present invention, there may be used phthalocyanine-based pigments such as metal-free phthalocyanine blue, phthalocyanine blue (copper phthalocyanine) and fast sky blue (sulfonated copper phthalocyanine), and alkali blue pigments, or the like. In the consideration of the blackness of the obtained non-magnetic composite particles, among these pigments, it is preferred to use of phthalocyanine-based pigments, more preferably phthalocyanine blue.

In particular, in the consideration of light resistance, the use of low-chlorinated copper phthalocyanine, NC-type (non-crystallization-type) copper phthalocyanine or NC-type low-chlorinated copper phthalocyanine is preferred.

The amount of the organic blue-based pigment adhered is usually 1 to 50 parts by weight, preferably 1.5 to 45 parts by weight, more preferably 2 to 40 parts by weight based on 100 parts by weight of the hematite particles.

When the amount of the organic blue-based pigment adhered is less than 1 part by weight, it may be difficult to obtain non-magnetic composite particles having sufficient light resistance and fluidity as well as the aimed hue because of the insufficient amount of the organic blue-based pigment adhered.

Next, the process for producing the non-magnetic composite particles according to the present invention, is described.

The hematite particles can be produced by the aforementioned methods.

The non-magnetic composite particles of the present invention can be produced by mixing hematite particles (A) or the black non-magnetic composite particles precursor (B) as non-magnetic core particles with alkoxysilane compounds or polysiloxanes to coat the surfaces of the non-magnetic core particles with the alkoxysilane compounds or polysiloxanes; and then mixing the non-magnetic core particles coated with the alkoxysilane compounds or polysiloxanes, with an organic blue-based pigment.

The coating of the hematite particles (A) or the black non-magnetic composite particles precursor (B) as non-magnetic core particles with the alkoxysilane compounds, the polysiloxanes, the modified polysiloxanes, or the terminal-modified polysiloxanes, may be conducted (i) by mechanically mixing and stirring the hematite particles (A) or the black non-magnetic composite particles precursor (B) together with the alkoxysilane compounds, the polysiloxanes, the modified polysiloxanes, or the terminal-modified polysiloxanes; or (ii) by mechanically mixing and stirring both the components together while spraying the alkoxysilane compounds, the polysiloxanes, the modified polysiloxanes, or the terminal-modified polysiloxanes onto the non-magnetic core particles. In these cases, substantially whole amount of the alkoxysilane compounds, the polysiloxanes, the modified polysiloxanes, or the terminal-modified polysiloxanes added can be applied onto the surfaces of the non-magnetic core particles.

In addition, by conducting the above-mentioned mixing or stirring treatment (i) of the hematite particles (A) or the black non-magnetic composite particles precursor (B) as non-magnetic core particles together with the alkoxysilane compounds, at least a part of the alkoxysilane compounds coated on the non-magnetic core particles may be changed to the organosilane compounds. In this case, there is also no affection against the formation of the organic blue-based pigment coat thereon.

In order to uniformly coat the surfaces of the hematite particles (A) or the black non-magnetic composite particles precursor (B) as non-magnetic core particles with the alkoxysilane compounds, the polysiloxanes, the modified polysiloxanes, or the terminal-modified polysiloxanes, it is preferred that the hematite particles (A) or the black non-magnetic composite particles precursor (B) are preliminarily diaggregated by using a pulverizer.

As apparatus (a) for mixing and stirring treatment (i) of the non-magnetic core particles with the alkoxysilane the polysiloxanes, the modified polysiloxanes, or the terminal-modified polysiloxanes to form the coating layer thereof, and as apparatus (b) for mixing and stirring treatment (ii) of the organic blue-based pigment with the non-magnetic core particles whose surfaces are coated with the alkoxysilane compounds, the polysiloxanes, the modified polysiloxanes, or the terminal-modified polysiloxanes to form the organic blue-based pigment coat, there may be preferably used those apparatus capable of applying a shear force to the particles, more preferably those apparatuses capable of conducting the application of shear force, spaturate force and compressed force at the same time.

As such apparatuses, there may be exemplified wheel-type kneaders, ball-type kneaders, blade-type kneaders, roll-type kneaders or the like. Among them, wheel-type kneaders are preferred.

Specific examples of the wheel-type kneaders may include an edge runner (equal to a mix muller, a Simpson mill or a sand mill), a multi-mull, a Stotz mill, a wet pan mill, a Conner mill, a ring muller, or the like. Among them, an edge runner, a multi-mull, a Stotz mill, a wet pan mill and a ring muller are preferred, and an edge runner is more preferred.

Specific examples of the ball-type kneaders may include a vibrating mill or the like. Specific examples of the blade-type kneaders may include a Henschel mixer, a planetary mixer, a Nawter mixer or the like. Specific examples of the roll-type kneaders may include an extruder or the like.

In order to coat the surfaces of the non-magnetic core particles with the alkoxysilane compounds, the polysiloxanes, the modified polysiloxanes, or the terminal-modified polysiloxanes as uniformly as possible, the conditions of the above mixing or stirring treatment may be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 to 120 minutes, preferably 10 to 90 minutes. It is preferred to appropriately adjust the stirring speed in the range of usually 2 to 2,000 rpm preferably 5 to 1,000 rμm more preferably 10 to 800 rpm.

The amount of the alkoxysilane compounds, the polysiloxanes, the modified polysiloxanes, or the terminal-modified polysiloxanes added, is preferably 0.15 to 45 parts by weight based on 100 parts by weight of the hematite particles (A) or the black non-magnetic composite particles precursor (B) as non-magnetic core particles. When the amount of the alkoxysilane compounds, the polysiloxanes, the modified polysiloxanes or the terminal-modified polysiloxanes added is less than 0.15 part by weight, it may become difficult to adhere the organic blue-based pigment in such an amount enough to obtain the non-magnetic composite particles according to the present invention. On the other hand, when the amount of the alkoxysilane compounds, the polysiloxanes, the modified polysiloxanes or the terminal-modified polysiloxanes added is more than 45 parts by weight, since a sufficient amount of the organic blue-based pigment can be adhered on the surface of the coating layer, it is meaningless to add more than 45 parts by weight.

Next, the organic blue-based pigment are added to the hematite particles (A) or the black non-magnetic composite particles precursor (B) as non-magnetic core particles, which are coated with the alkoxysilane compounds, the polysiloxanes, the modified polysiloxanes, or the terminal-modified polysiloxanes, and the resultant mixture is mixed and stirred to form the organic blue-based pigment coat on the surfaces of the coating layer composed of the alkoxysilane compounds, the polysiloxanes, the modified polysiloxanes or the terminal-modified polysiloxanes. The drying or heat-treatment may be conducted.

It is preferred that the organic blue-based pigment are added little by little and slowly, especially about 5 to 60 minutes.

In order to form organic blue-based pigment coat onto the coating layer composed of the alkoxysilane compounds, the polysiloxanes, the modified polysiloxanes, or the terminal-modified polysiloxanes as uniformly as possible, the conditions of the above mixing or stirring treatment can be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 to 120 minutes, preferably 10 to 90 minutes. It is preferred to appropriately adjust the stirring speed in the range of usually 2 to 2,000 rpm, preferably 5 to 1,000 rpm, more preferably 10 to 800 rpm.

The preferable amount of the organic blue-based pigment added is 1 to 50 parts by weight based on 100 parts by weight of the hematite particles (A) or the black non-magnetic composite particles precursor (B). When the amount of the organic blue-based pigment added is less than 1 parts by weight, it may be difficult to obtain non-magnetic composite particles having sufficient light resistance and fluidity as well as the aimed hue because of the insufficient amount of the organic blue-based pigment adhered.

In case of drying the obtained non-magnetic composite particles, the temperature is usually 40 to 150° C., preferably 60 to 120° C. The treating time of these steps is usually from 10 minutes to 12 hours, preferably from 30 minutes to 3 hours.

When the obtained non-magnetic composite particles is subjected to the above step, the alkoxysilane compounds used as the coating thereof are finally converted into organosilane compounds.

If required, prior to mixing and stirring with the alkoxysilane compounds or polysiloxanes, the hematite particles may be preliminarily coated with at least one compound selected from the group consisting of hydroxides of aluminum, oxides of aluminum, hydroxides of silicon and oxides of silicon to form an intermediate coating layer thereon.

At least a part of the surface of the hematite particles may be coated with at least one compound selected from the group consisting of hydroxides of aluminum, oxides of aluminum, hydroxides of silicon and oxides of silicon (hereinafter referred to merely as “hydroxides and/or oxides of aluminum and/or silicon”), if required, in advance of mixing and stirring with the alkoxysilane compounds, the polysiloxanes, the modified polysiloxanes or the terminal-modified polysiloxanes.

The coating of the hydroxides and/or oxides of aluminum and/or silicon may be conducted by adding an aluminum compound, a silicon compound or both the compounds to a water suspension in which the hematite particles are dispersed, followed by mixing and stirring, and further adjusting the pH value of the suspension, if required, thereby coating the surfaces of the hematite particles with hydroxides and/or oxides of aluminum and/or silicon. The thus obtained hematite particles coated with the hydroxides and/or oxides of aluminum and/or silicon are then filtered out, washed with water, dried and pulverized. Further, the hematite particles coated with the hydroxides and/or oxides of aluminum and/or silicon may be subjected to post-treatments such as deaeration treatment and compaction treatment, if required.

As the aluminum compounds, there may be exemplified aluminum salts such as aluminum acetate, aluminum sulfate, aluminum chloride or aluminum nitrate, alkali aluminates such as sodium aluminate or the like.

The amount of the aluminum compound added is 0.01 to 50% by weight (calculated as Al) based on the weight of the hematite particles. When the amount of the aluminum compound added is less than 0.01% by weight, it may be difficult to sufficiently coat the surfaces of the hematite particles with hydroxides and/or oxides of aluminum, thereby failing to improve the effective reduction of the organic blue-based pigment desorption percentage. On the other hand, when the amount of the aluminum compound added is more than 50% by weight, the coating effect is saturated and, therefore, it is meaningless to add such an excess amount of the aluminum compound.

As the silicon compounds, there may be exemplified #3 water glass, sodium orthosilicate, sodium metasilicate or the like.

The amount of the silicon compound added is 0.01 to 50% by weight (calculated as SiO₂) based on the weight of the hematite particles.

In the case where both the aluminum and silicon compounds are used in combination for the coating, the total amount of the aluminum and silicon compounds added is preferably 0.01 to 50% by weight (calculated as a sum of Al and SiO₂) based on the weight of the hematite particles.

Next, the black toner according to the present invention is described.

The black toner according to the present invention comprises the non-magnetic composite particles and a binder resin. The black toner may further contain a mold release agent, a colorant, a charge-controlling agent and other additives, if necessary.

The black toner according to the present invention has an average particle size of usually 3 to 25 μm, preferably 4 to 18 μm, more preferably 5 to 15 μm.

The amount of the binder resin used in the black toner is usually 50 to 3500 parts by weight, preferably 50 to 2000 parts by weight, more preferably 50 to 1000 parts by weight based on 100 parts by weight of the non-magnetic composite particles.

As the binder resins, there may be used vinyl-based polymers, i.e., homopolymers or copolymers of vinyl-based monomers such as styrene, alkyl acrylates and alkyl methacrylates. As the styrene monomers, there may be exemplified styrene and substituted styrenes. As the alkyl acrylate monomers, there may be exemplified acrylic acid, methyl acrylate, ethyl acrylate, butyl acrylate or the like.

It is preferred that the above copolymers contain styrene-based components in an amount of usually 50 to 95% by weight.

In the binder resin used in the present invention, the above-mentioned vinyl-based polymers may be used in combination with polyester-based resins, epoxy-based resins, polyurethane-based resins or the like, if necessary.

The black toner according to the present invention exhibits a flowability index of usually 70 to 100; an L* value of usually 2.0 to 15.0; an a* value of usually −2.0 to 0.0; a b* value of usually −3.0 to 5.5; a light resistance (ΔE* value) of usually not more than 5.0; a volume resistivity value of usually not less than 1.0×10¹³ Ω·cm.

In the case where the hematite particles (A) are used as non-magnetic core particles, the properties of the obtained black toner are described below.

As to the fluidity of the black toner according to the present invention, the fluidity index is usually 70 to 100, preferably 71 to 100, more preferably 72 to 100. When the fluidity index is less than 70, the black toner may not show a sufficient fluidity.

As to the hue of the black toner, the lower limit of L* value thereof is 3.0, and the upper limit of the L* value is usually 15.0, preferably 13.5, more preferably 11.0; the lower limit of a* value thereof is usually −2.0, and the upper limit of the a* value is usually 0.0, preferably −0.1, more preferably −0.2; and the lower limit of b* value thereof is usually −3.0, and the upper limit of the b* value is usually 5.5, preferably 5.0. When the L* value exceeds 15.0, the lightness of the black toner is increased, so that it may be difficult to obtain a black toner having a sufficient blackness. When the a* value exceeds 0.0, the obtained black toner may exhibit a reddish color, so that it may be difficult to obtain a black toner having a deep black color.

As to the light resistance of the black toner, the ΔE* value thereof is usually not more than 5.0, preferably not more than 4.0, when measured by the below-mentioned method.

The volume resistivity of the black toner according to the present invention is usually not less than 1.0×10¹³ Ω·cm, preferably not less than 3.0×10¹³ Ω·cm, more preferably not less than 6.0×10¹³ Ω·cm. When the volume resistivity is less than 1.0×10¹³ Ω·cm, the charge amount of the black toner may tend to vary depending upon environmental conditions in which the toner is used, resulting in unstable properties of the black toner. The upper limit of the volume resistivity is 1.0×10¹⁷ Ω·cm. In the case where the black non-magnetic composite particles precursor (B) is used as non-magnetic core particles, the properties of the obtained black toner are described below.

As to the fluidity of the black toner according to the present invention, the fluidity index is usually 70 to 100, preferably 71 to 100, more preferably 72 to 100.

As to the hue of the black toner, the lower limit of L* value thereof is 2.0, and the upper limit of the L* value is usually 11.0, preferably 10.0, more preferably 8.5; the lower limit of a* value thereof is usually −2.0, and the upper limit of the a* value is usually 0.0, preferably −0.1, more preferably −0.2; and the lower limit of b* value thereof is usually −3.0, and the upper limit of the b* value is usually 5.5, preferably 5.0.

As to the light resistance of the black toner, the ΔE* value thereof is usually not more than 5.0, preferably not more than 4.0, when measured by the below-mentioned method.

The volume resistivity of the black toner according to the present invention is usually not less than 1.0×10¹³ Ω·cm, preferably not less than 3.0×10¹³ Ω·cm, more preferably not less than 5.0×10¹³ Ω·cm. The upper limit of the volume resistivity is 1.0×10¹⁷ Ω·cm.

Next, the process for producing the black toner according to the present invention is described.

The black toner according to the present invention may be produced by a known method of mixing and kneading a predetermined amount of a binder resin and a predetermined amount of the non-magnetic composite particles together, and then pulverizing the mixed and kneaded material into particles. More specifically, the non-magnetic composite particles and the binder resin are intimately mixed together with, if necessary, a mold release agent, a colorant, a charge-controlling agent or other additives by using a mixer. The obtained mixture is then melted and kneaded by a heating kneader so as to render the respective components compatible with each other, thereby dispersing the non-magnetic composite particles therein. Successively, the molten mixture is cooled and solidified to obtain a resin mixture. The obtained resin mixture is then pulverized and classified, thereby producing a toner having an aimed particle size.

As the mixers, there may be used a Henschel mixer, a ball mill or the like. As the heating kneaders, there may be used a roll mill, a kneader, a twin-screw extruder or the like. The pulverization of the resin mixture may be conducted by using pulverizers such as a cutter mill, a jet mill or the like. The classification of the pulverized particles may be conducted by known methods such as air classification, etc., as described in Japanese Patent No. 2683142 or the like.

As the other method of producing the black toner, there may be exemplified a suspension polymerization method or an emulsion polymerization method. In the suspension polymerization method, polymerizable monomers and the non-magnetic composite particles are intimately mixed together with, if necessary, a colorant, a polymerization initiator, a cross-linking agent, a charge-controlling agent or the other additives and then the obtained mixture is dissolved and dispersed together so as to obtain a monomer composition. The obtained monomer composition is added to a water phase containing a suspension stabilizer while stirring, thereby granulating and polymerizing the composition to form toner particles having an aimed particle size.

In the emulsion polymerization method, the monomers and the non-magnetic composite particles are dispersed in water together with, if necessary, a colorant, a polymerization initiator or the like and then the obtained dispersion is polymerized while adding an emulsifier thereto, thereby producing toner particles having an aimed particle size.

The point of the present invention is that the non-magnetic composite particles comprising hematite particles or black non-magnetic composite particles precursor on the surface of which the organic blue-based pigment is adhered through organosilane compounds or polysiloxanes, can exhibit not only a more deep black color but also more excellent fluidity and light resistance.

The reason why the non-magnetic composite particles of the present invention can exhibit a deep black color, is considered as follows, though not clearly determined. That is, by selecting the organic blue-based pigment as a pigment capable of reducing the red color of hematite particles, and selecting the alkoxysilane or polysiloxanes as a gluing agent capable of strongly anchoring the organic blue-based pigment onto the hematite particles or black non-magnetic composite particles precursor, the a* value (as an index of red color) of the obtained non-magnetic composite particles can be reduced to not more than 0.

The reason why the non-magnetic composite particles of the present invention can exhibit an excellent fluidity, is considered by the present inventors as follows. That is, since the organic blue-based pigment is uniformly and densely adhered onto the surface of each hematite particle or black non-magnetic composite particles precursor, a number of fine irregularities are formed on the surface of the hematite particle or black non-magnetic composite particles precursor.

The reason why the non-magnetic composite particles of the present invention can exhibit an excellent light resistance, is considered as follows. That is, since the hematite particles or black non-magnetic composite particles precursor are coated with the organosilane compounds or polysiloxanes having an excellent light resistance and further the organic blue-based pigment is adhered onto the coating layer comprising the organosilane compounds or polysiloxanes, the light resistance of the obtained non-magnetic composite particles can be considerably improved.

A further point of the present invention is that the black toner produced using the above non-magnetic composite particles on which the organic blue-based pigment is adhered, can also exhibit not only excellent light resistance and fluidity but also a deep black color while maintaining a volume resistivity as high as not less than 1×10¹³ Ω·cm.

The reason why the black toner of the present invention can exhibit an excellent fluidity, is considered by the present inventors as follows. That is, since the non-magnetic composite particles comprising the hematite particles or black non-magnetic composite particles precursor onto which the organic blue-based pigment is adhered, are exposed to the surface of the black toner, a number of fine irregularities are formed on the surface of the black toner.

The reason why the black toner of the present invention can exhibit a deep black color, is considered by the present inventors as follows. That is, since the non-magnetic composite particles having a sufficiently low L* value and an a* value of not more than 0 are blended in the black toner, the obtained black toner can also exhibit a deep black color.

Thus, the non-magnetic composite particles of the present invention can exhibit not only a deep black color but also excellent fluidity and light resistance and, therefore, are suitably used as non-magnetic composite particles for black toner.

Further, the black toner produced using the non-magnetic composite particles capable of exhibiting not only a more deep black color but also more excellent fluidity and light resistance, can also exhibit a deep black color as well as more excellent fluidity and light resistance. Therefore, the black toner of the present invention can provide a suitable black toner.

### EXAMPLES

The present invention is described in more detail by Examples and Comparative Examples, but the Examples are only illustrative and, therefore, not intended to limit the scope of the present invention.

Various properties were measured by the following methods.

(1) The average particle size of the particles was expressed by average values (measured in a predetermined direction) of about 350 particles which were sampled from a micrograph obtained by magnifying an original electron micrograph by four times in each of the longitudinal and transverse directions.

(2) The sphericity of the particles was expressed by a ratio of average major diameter to average minor diameter thereof.

(3) The geometrical standard deviation of particle sizes was expressed by values obtained by the following method. That is, the particle sizes were measured from the above magnified electron micrograph. The actual particle sizes and the number of the particles were obtained from the calculation on the basis of the measured values. On a logarithmic normal probability paper, the particle sizes were plotted at regular intervals on the abscissa-axis and the accumulative number (under integration sieve) of particles belonging to each interval of the particle sizes were plotted by percentage on the ordinate-axis by a statistical technique.

The particle sizes corresponding to the number of particles of 50% and 84.13%, respectively, were read from the graph, and the geometrical standard deviation (under integration sieve) was measured from the following formula:

Geometrical standard deviation=

{particle sizes corresponding to 84.13% under integration sieve}/{particle sizes (geometrical average diameter) corresponding to 50% under integration sieve}

The closer to 1 the geometrical standard deviation value, the more excellent the particle size distribution of the particle sizes.

(4) The specific surface area was expressed by values measured by a BET method.

(5) The amounts of Mn, Al and Si which were present within hematite or on the surfaces thereof; and the amount of Si contained in the coating layer composed of organosilicon compounds, were measured by a fluorescent X-ray spectroscopy device “3063 M-type” (manufactured by RIGAKU DENKI KOGYO CO., LTD.) according to JIS K0119 “General rule of fluorescent X-ray analysis”.

Meanwhile, the amount of Si contained in oxides of silicon, hydroxides of silicon and organosilicon compounds coated on the surfaces of the hematite particles or the black non-magnetic composite particles precursor, is expressed by the value obtained by subtracting the amount of Si measured prior to the respective treatment steps from that measured after the respective treatment steps.

(6) The amount of carbon black coat formed at the surface of the black non-magnetic composite particles precursor was measured by “Horiba Metal, Carbon and Sulfur Analyzer EMIA-2200 Model” (manufactured by Horiba Seisakusho Co., Ltd.).

(7) The thickness of carbon black coat formed at the surfaces of the black non-magnetic composite particles precursor is expressed by the value which was obtained by first measuring an average thickness of carbon black coat formed onto the surfaces of the particles on a photograph (×5,000,000) obtained by magnifying (ten times) a micrograph (×500,000) produced at an accelerating voltage of 200 kV using a transmission-type electron microscope (JEM-2010, manufactured by Japan Electron Co., Ltd.), and then calculating an actual thickness of carbon black coat formed from the measured average thickness.

(8) The amount of the adhered organic blue-based pigments of the non-magnetic composite particles was obtained by measuring the carbon content thereof using “HORIBA METAL CARBON/SULFUR ANALYZER EMIA-2200 MODEL” (manufactured by Horiba Seisakusho Co., Ltd.).

(9) The fluidity of hematite particles, black non-magnetic composite particles precursor, non-magnetic composite particles and black toner was expressed by a fluidity index which was a sum of indices obtained by converting on the basis of the same reference measured values of an angle of repose, a degree of compaction (%), an angle of spatula and a degree of agglomeration as particle characteristics which were measured by a powder tester (tradename, produced by Hosokawa Micron Co., Ltd.). The closer to 100 the fluidity index, the more excellent the fluidity of the particles.

(10) The hue of each of the hematite particles, black non-magnetic composite particles precursor, non-magnetic composite particles, the organic blue-based pigment and the black toner, were measured by the following method.

That is, 0.5 g of each sample and 1.5 ml of castor oil were intimately kneaded together by a Hoover's muller to form a paste. 4.5 g of clear lacquer was added to the obtained paste and was intimately mixed to form a paint. The paint was applied on a cast-coated paper by using a 150 μm (6-mil) applicator to produce a coating film piece (having a film thickness of about 30 μm). The thus obtained coating film piece was measured by a portable spectrophotometer Color Guide 45/0 (manufactured by BYK-chemie Japan K. K.) to determine L*, a* and b* values thereof.

The L* value represents a lightness, and the smaller the L* value, the more excellent the blackness. The a* value represents a redness, and the smaller the a* value, the less the redness.

(11) The light resistances of the hematite particles, black non-magnetic composite particles precursor, non-magnetic composite particles, organic blue-based pigment and black toner were measured by the following method.

Ten grams of sample particles, 16 g of an aminoalkyd resin and 6 g of a thinner were charged together with 90 g of 3 mmφ glass beads into a 140-ml glass bottle, and then mixed and dispersed for 45 minutes by a paint shaker. The resultant mixture was mixed with additional 50 g of the aminoalkyd resin, and further dispersed for 5 minutes by a paint shaker, thereby obtaining a coating composition. The thus obtained coating composition was applied onto a cold-rolled steel plate (0.8 mm×70 m×150 mm; JIS G-3141) and dried to form a coating film having a thickness of 150 μm. One half of the thus prepared test specimen was covered with a metal foil, and an ultraviolet light was continuously irradiated over the test specimen at an intensity of 100 mW/cm² for 6 hours using “EYE SUPER UV TESTER SUV-W13” manufactured by Iwasaki Denki Co., Ltd. Then, the hues (L*, a* and b* values) of the metal foil-covered non-irradiated portion and the UV-irradiated portion of the test specimen were respectively measured. The ΔE* value was calculated from differences between the measured hue values of the metal foil-covered non-irradiated portion and the UV-irradiated portion according to the following formula:

ΔE*=[(ΔL*)²+(Δa*)²+(Δb*)²]^{½}

wherein AL* represents the difference between L* values of the non-irradiated and UV-irradiated portions; Δa* represents the difference between a* values of the non-irradiated and UV-irradiated portions; and Δb* represents the difference between b* values of the non-irradiated and UV-irradiated portions.

(12) The desorption percentage of carbon black desorbed from the black non-magnetic composite particles precursor was measured by the following method. The closer to 0% the desorption percentage, the smaller the amount of carbon black desorbed from the surfaces of black non-magnetic composite particles precursor.

That is, 3 g of the black non-magnetic composite particles precursor and 40 ml of ethanol were placed in a 50-ml precipitation pipe and then was subjected to ultrasonic dispersion for 20 minutes. Thereafter, the obtained dispersion was allowed to stand for 120 minutes, and the carbon black desorbed were separated from the black non-magnetic composite particles precursor on the basis of the difference in specific gravity between both the particles. Next, the black non-magnetic composite particles precursor from which the desorbed carbon black was separated, were mixed again with 40 ml of ethanol, and the obtained mixture was further subjected to ultrasonic dispersion for 20 minutes. Thereafter, the obtained dispersion was allowed to stand for 120 minutes, thereby separating the black non-magnetic composite particles precursor and the (desorbed) carbon black desorbed from each other. The thus obtained black non-magnetic composite particles precursor were dried at 80° C. for one hour, and then the carbon content thereof was measured by the “Horiba Metal, Carbon and Sulfur Analyzer EMIA-2200 Model” (manufactured by Horiba Seisakusho Co., Ltd.). The desorption percentage of the carbon black was calculated according to the following formula:

Desorption percentage of

carbon black (%)={(Wₐ−Wₑ)/Wₐ}×100

wherein Wₐ represents an amount of carbon black initially formed on the black non-magnetic composite particles precursor; and We represents an amount of carbon black still adhered on the black non-magnetic composite particles precursor after desorption test.

(13) The desorption percentage of the organic blue-based pigment desorbed from the non-magnetic composite particles, is expressed by the value measured by the following method. The closer to 0% the desorption percentage of the organic blue-based pigment, the less the amount of the organic blue-based pigment desorbed from the surface of the non-magnetic composite particles.

Three grams of the non-magnetic composite particles and 40 ml of ethanol were placed in a 50-ml precipitation tube, and subjected to ultrasonic dispersion for 20 minutes. The obtained dispersion was allowed to stand for 120 minutes, thereby separating the dispersion into the non-magnetic composite particles and the organic blue-based pigments desorbed therefrom due to the difference in precipitating speed therebetween. Subsequently, the non-magnetic composite particles were mixed again with 40 ml of ethanol, and subjected to ultrasonic dispersion for 20 minutes. The obtained dispersion was allowed to stand for 120 minutes, thereby separating the dispersion into the non-magnetic composite particles and the organic blue-based pigment. The thus separated non-magnetic composite particles were dried at 80° C. for one hour to measure the amount of the organic blue-based pigment desorbed therefrom. The desorption percentage (%) of the organic blue-based pigment is calculated according to the following formula:

Desorption percentage (%) of organic

blue-based pigment={(Wab-Web)/Wab}—100

wherein Wab represents an amount of the organic blue-based pigment adhered onto the non-magnetic composite particles ; and Web represents an amount of the organic blue-based pigment adhered onto the non-magnetic composite particles after desorption test.

(14) The dispersibility in a binder resin of the non-magnetic composite particles was evaluated by counting the number of undispersed agglomerated particles on a micrograph (×200 times) obtained by photographing a sectional area of the obtained black toner particle using an optical microscope (BH-2, manufactured by Olympus Kogaku Kogyo Co., Ltd.), and classifying the results into the following five ranks. The 5th rank represents the most excellent dispersing condition.

Rank 1: not less than 50 undispersed agglomerated particles per 0.25 mm² were recognized;

Rank 2: 10 to 49 undispersed agglomerated particles per 0.25 mm² were recognized;

Rank 3: 5 to 9 undispersed agglomerated particles per 0.25 mm2 were recognized;

Rank 4: 1 to 4 undispersed agglomerated particles per 0.25 mm2 were recognized;

Rank 5: No undispersed agglomerated particles were recognized.

(15) The average particle size of the black toner was measured by a laser diffraction-type particle size distribution-measuring apparatus (Model HELOSLA/KA, manufactured by Sympatec Corp.).

(16) The volume resistivity of the hematite particles, black non-magnetic composite particles precursor, the non-magnetic composite particles and the black toner was measured by the following method.

That is, first, 0.5 g of a sample particles or toner to be measured was weighted, and press-molded at 1.372×10⁷Pa (140 Kg/cm²) using a KBr tablet machine (manufactured by Simazu Seisakusho Co., Ltd.), thereby forming a cylindrical test piece.

Next, the thus obtained cylindrical test piece was exposed to an atmosphere maintained at a temperature of 25° C. and a relative humidity of 60% for 12 hours. Thereafter, the cylindrical test piece was set between stainless steel electrodes, and a voltage of 15V was applied between the electrodes using a Wheatstone bridge (TYPE2768, manufactured by Yokogawa-Hokushin Denki Co., Ltd.) to measure a resistance value R (Ω).

The cylindrical test piece was measured with respect to an upper surface area A (cm²) and a thickness t (cm) thereof. The measured values were inserted into the following formula, thereby obtaining a volume resistivity xΩ·cm.

x(Ω·cm)=R×(A/t₀)

### Example 1

### Production of Non-magnetic Composite Particles

20 kg of black-brown hematite particles (particle shape: granular shape; average particle size: 0.29 μm; sphericity: 1.29; geometrical standard deviation value: 1.43; BET specific surface area value:3.8 m²/g; Mn content: 13.1% by weight (calculated as Mn) based on the weight of the particle; fluidity index: 35; blackness (L* value): 13.0; a* value: 2.9; b* value: 4.8; light resistance (ΔE* value): 7.3; volume resistivity: 5.1×10⁷ Ω·cm), were deagglomerated in 150 liters of pure water using a stirrer, and further passed through a “TK pipeline homomixer” (tradename, manufactured by Tokushu Kika Kogyo Co., Ltd.) three times, thereby obtaining a slurry containing the black-brown hematite particles.

Successively, the obtained slurry containing the black-brown hematite particles was passed through a transverse-type sand grinder (tradename “MIGHTY MILL MHG-1.5L”, manufactured by Inoue Seisakusho Co., Ltd.) five times at an axis-rotating speed of 2,000 rpm, thereby obtaining a slurry in which the black-brown hematite particles were dispersed.

The particles in the obtained slurry which remained on a sieve of 325 meshes (mesh size: 44 μm) was 0%. The slurry was filtered and washed with water, thereby obtaining a filter cake containing the black-brown hematite particles. After the obtained filter cake containing the black-brown hematite particles was dried at 120° C., 11.0 kg of the dried particles were then charged into an edge runner “MPUV-2 Model” (tradename, manufactured by Matsumoto Chuzo Tekkosho Co., Ltd.), and mixed and stirred at 294 N/cm (30 Kg/cm) and a stirring speed of 22 rpm for 30 minutes, while introducing a N₂ gas at a rate of 2 1/minute, thereby lightly deagglomerating the particles.

110 g of methyltriethoxysilane (tradename: “TSL8123”, produced by GE TOSHIBA SILICONE CO., LTD.) was mixed and diluted with 200 ml of ethanol to obtain a methyltriethoxysilane solution. The methyltriethoxysilane solution was added to the deagglomerated black-brown hematite particles under the operation of the edge runner. The black-brown hematite particles were continuously mixed and stirred at a linear load of 588 N/cm (60 Kg/cm) and a stirring speed of 22 rpm for 20 minutes to form a coating layer composed of methyltriethoxysilane on the black-brown hematite particles.

Next, 1100 g of an organic blue-based pigment A (kind: Copper phthalocyanine blue; particle shape: granular shape; average major axial diameter: 0.06 μm; BET specific surface area: 71.6 m²/g; L* value: 5.2; a* value: 9.7; b* value: -21.8; light resistance (ΔE* value): 4.8), were added to the above mixture for 10 minutes while operating the edge runner. Further, the obtained mixture was mixed and stirred at a linear load of 588 N/cm (60 Kg/cm) and a stirring speed of 22 rpm for 20 minutes to form a coating layer composed of the organic blue-based pigment A on the methyltriethoxysilane coat, thereby obtaining composite particles. The obtained composite particles were heat-treated at 105° C. for 60 minutes by using a drier, thereby obtaining non-magnetic composite particles.

The obtained non-magnetic composite particles had an average particle diameter of 0.30 μm, a sphericity of 1.29:1, a geometrical standard deviation value of 1.43, a BET specific surface area value of 7.2 m²/g, a fluidity index of 51, a blackness (L* value) of 7.6, an a* value of −0.60, a b* value of −1.3, a light resistance (ΔE* value) of 3.3, a volume resistivity of 8.1×10⁶ Ω·cm. The desorption percentage of the organic blue-based pigment A from the non-magnetic composite particles was 5.7% by weight.

The amount of a coating layer composed of organosilane compounds produced from methyltriethoxysilane was 0.15% by weight (calculated as Si). The amount of the coating layer composed of the organic blue-based pigment A was 6.00% by weight (calculated as C) (corresponding to 10 parts by weight based on 100 parts by weight of the black-brown hematite particles).

As a result of the observation of electron micrograph, almost no organic blue-based pigment A liberated was recognized, so that it was confirmed that a substantially whole amount of the organic blue-based pigment A added was adhered on the coating layer composed of the organosilane compounds produced from methyltriethoxysilane.

### Production of Black Toner

150 g of the non-magnetic composite particles obtained, 765 g of styrene-butyl acrylate-methyl methacrylate copolymer resin (molecular weight=130,000, styrene/butyl acrylate/methyl methacrylate=82.0/16.5/1.5), 85 g of polypropylene wax (molecular weight: 3,000) and 15 g of a charge-controlling agent were charged into a Henschel mixer, and mixed and stirred therein at 60° C. for 15 minutes. The obtained mixed particles were melt-kneaded at 140° C. using a continuous-type twin-screw kneader (T-1), and the obtained kneaded material was cooled, coarsely pulverized and finely pulverized in air. The obtained particles were subjected to classification, thereby producing a black toner.

The obtained black non-black toner had an average particle size of 10.0 μm, a dispersibility of 5th rank, a fluidity index of 79, a blackness (L* value) of 8.2, an a* value of −0.50, a b* value of −0.9, a light resistance (ΔE* value) of 2.9, a volume resistivity of 4.5×10¹⁴ Ω·cm.

### Example 2:

### Production of Black Non-magnetic Composite Particles Precursor

20 kg of black-brown hematite particles (particle shape: granular shape; average particle size: 0.30 μm; sphericity: 1.3:1; geometrical standard deviation value: 1.48; BET specific surface area value: 4.0 m²/g; blackness (L* value): 13.2; a* value: 3.2; b* value: 5.9; light resistance (ΔE* value): 7.2; Mn content: 13.3% by weight (calculated as Mn) based on the weight of the particle; fluidity index: 34; volume resistivity: 4.6×10⁷ Ω·cm), were deagglomerated in 150 liters of pure water using a stirrer, and further passed through a “TK pipeline homomixer”(tradename, manufactured by Tokushu Kika Kogyo Co., Ltd.) three times, thereby obtaining a slurry containing the black-brown hematite particles.

Successively, the obtained slurry containing the black-brown hematite particles was passed through a transverse-type sand grinder (tradename “MIGHTY MILL MHG-1.5L”, manufactured by Inoue Seisakusho Co., Ltd.) five times at an axis-rotating speed of 2,000 rpm, thereby obtaining a slurry in which the black-brown hematite particles were dispersed.

The particles in the obtained slurry which remained on a sieve of 325 meshes (mesh size: 44 μm) was 0%. The slurry was filtered and washed with water, thereby obtaining a filter cake containing the black-brown hematite particles. After the obtained filter cake containing the black-brown hematite particles was dried at 120° C., 11.0 kg of the dried particles were then charged into an edge runner “MPUV-2 Model” (tradename, manufactured by Matsumoto Chuzo Tekkosho Co., Ltd.), and mixed and stirred at 294 N/cm(30 Kg/cm) and a stirring speed of 22 rpm for 30 minutes, thereby lightly deagglomerating the particles.

275 g of methyltriethoxysilane (tradename: “TSL8123”, produced by GE TOSHIBA SILICONE CO., LTD.) was mixed and diluted with 200 ml of ethanol to obtain a methyltriethoxysilane solution. The methyltriethoxysilane solution was added to the deagglomerated black-brown hematite particles under the operation of the edge runner. The black-brown hematite particles were continuously mixed and stirred at a linear load of 588 N/cm (60 Kg/cm) and a stirring speed of 22 rpm for 60 minutes to form a coating layer composed of methyltriethoxysilane on the black-brown hematite particles.

Next, 1100 g of carbon black fine particles (particle shape: granular shape; average particle size: 0.022 μm; geometrical standard deviation value: 1.68; BET specific surface area value: 134 m²/g; and blackness (L* value): 5.0) were added to the black-brown hematite particles coated with methyltriethoxysilane for 10 minutes while operating the edge runner. Further, the mixed particles were continuously stirred at a linear load of 588 N/cm (60 Kg/cm) and a stirring speed of 22 rpm for 60 minutes to form the carbon black coat on the coating layer composed of methyltriethoxysilane, thereby obtaining black composite particles. The obtained black composite particles were heat-treated at 105° C. for 60 minutes by using a drier, thereby obtaining a black composite particles precursor.

The obtained back black non-magnetic composite particles precursor had an average particle diameter of 0.30 μm, a sphericity of 1.3:1, a geometrical standard deviation value of 1.48, a BET specific surface area value of 6.6 m²/g, a fluidity index of 46, a blackness (L* value) of 7.5, an a* value of 2.8, a b* value of 1.8, a light resistance (ΔE* value) of 4.8, a volume resistivity of 4.1×10⁴ Ω·cm. The desorption percentage of the carbon black from the black non-magnetic composite particles precursor was 7.5% by weight.

The coating amount of an organosilane compound produced from methyltriethoxysilane was 0.38% by weight calculated as Si. The amount of the carbon black coat formed on the coating layer composed of the organosilane compound produced from methyltriethoxysilane is 9.04% by weight (calculated as C) based on the weight of the black non-magnetic composite particles precursor (corresponding to 10 parts by weight based on 100 parts by weight of the black-brown hematite particles). The thickness of the carbon black coat formed was 0.0024 μm. Since no independent carbon black was observed on the electron micrograph, it was determined that a whole amount of the carbon black used contributed to the formation of the carbon black coat on the coating layer composed of the organosilane compound produced from methyltriethoxysilane.

### Production of Non-magnetic Composite Particles

The thus obtained black non-magnetic composite particles precursor 11.0 kg were charged into an edge runner “MPUV-2 Model” (tradename, manufactured by Matsumoto Chuzo Tekkosho Co., Ltd.), and mixed and stirred at 294 N/cm (30 Kg/cm) and a stirring speed of 22 rpm for 30 minutes, thereby lightly deagglomerating the particles.

110 g of methyltriethoxysilane was mixed and diluted with 200 ml of ethanol to obtain a methyltriethoxysilane solution. The methyltriethoxysilane solution was added to the deagglomerated black non-magnetic composite particles precursor under the operation of the edge runner. The black non-magnetic composite particles precursor were continuously mixed and stirred at a linear load of 588 N/cm (60 Kg/cm) and a stirring speed of 22 rpm for 30 minutes to form a coating layer composed of methyltriethoxysilane on the black non-magnetic composite particles precursor.

Next, 1100 g of an organic blue-based pigment A (kind: copper phthalocyanine blue; particle shape: granular shape; average major axial diameter: 0.06 μm; BET specific surface area: 71.6 m²/g; L* value: 5.2; a* value: 9.7; b* value: −21.8; light resistance (ΔE* value): 4.8), were added to the above mixture for 10 minutes while operating the edge runner. Further, the obtained mixture was mixed and stirred at a linear load of 588 N/cm (60 Kg/cm) and a stirring speed of 22 rpm for 30 minutes to form a coating layer composed of the organic blue-based pigment A on the methyltriethoxysilane coat, thereby obtaining composite particles. The obtained composite particles were heat-treated at 80° C for 60 minutes by using a drier, thereby obtaining non-magnetic composite particles.

The obtained non-magnetic composite particles had an average particle diameter of 0.30 μm, a sphericity of 1.3:1, a geometrical standard deviation value of 1.48, a BET specific surface area value of 9.3 m²/g, a fluidity index of 54, a blackness (L* value) of 6.4, an a* value of −0.2, a b* value of −0.7, a light resistance (ΔE* value) of 2.1, a volume resistivity of 5.2×10⁶ Ω·cm. The desorption percentage of the organic blue pigment from the non-magnetic composite particles was 5.1% by weight.

The amount of a coating layer composed of organosilane compounds produced from methyltriethoxysilane was 0.15% by weight (calculated as Si). The amount of the coating layer composed of the organic blue-based pigment A was 6.04% by weight (calculated as C) (corresponding to 10 parts by weight based on 100 parts by weight of the black non-magnetic composite particles precursor).

As a result of the observation of electron micrograph, almost no organic blue-based pigment A liberated was recognized, so that it was confirmed that a substantially whole amount of the organic blue-based pigment A added was adhered on the coating layer composed of the organosilane compounds produced from methyltriethoxysilane.

### Production of Black Toner

150 g of the thus obtained non-magnetic composite particles obtained, 765 g of styrene-butyl acrylate-methyl methacrylate copolymer resin (molecular weight=130,000, styrene/butyl acrylate/methyl methacrylate=82.0/16.5/1.5), 85 g of polypropylene wax (molecular weight: 3,000) and 15 g of a charge-controlling agent were charged into a Henschel mixer, and mixed and stirred therein at 60° C. for 15 minutes.

The obtained mixed particles were melt-kneaded at 140° C. using a continuous-type twin-screw kneader (T-1), and the obtained kneaded material was cooled, coarsely pulverized and finely pulverized in air. The obtained particles were subjected to classification, thereby producing a black toner.

The obtained black toner had an average particle size of 9.9 μm, a dispersibility of 5th rank, a fluidity index of 82, a blackness (L* value) of 6.9, an a* value of −0.2, a b* value of −0.8, a light resistance (ΔE* value) of 1.9, a volume resistivity of 8.3×10¹³ Ω·cm.

Hematite Particles 1 to 3

Various hematite particles were used as non-magnetic core particles.

Various properties of the thus obtained hematite particles are shown in Table 1.

Hematite Particles 4

The same procedure as defined in Example 1 was conducted by using 20 kg of the deagglomerated black-brown hematite particles (hematite particles 1) and 150 liters of water, thereby obtaining a slurry containing the black-brown hematite particles. The pH value of the obtained re-dispersed slurry containing the black-brown hematite particles was adjusted to 10.5 using an aqueous sodium hydroxide solution, and then the concentration of the solid content in the slurry was adjusted to 98 g/liter by adding water thereto. After 150 liters of the slurry was heated to 60° C., 2722 ml of a 1.0 mol/liter sodium aluminate solution (corresponding to 0.5% by weight (calculated as Al) based on the weight of the black-brown hematite particles) was added to the slurry. After allowing the obtained slurry to stand for 30 minutes, the pH value of the obtained slurry was adjusted to 7.5 by adding acetic acid thereto. After further allowing the slurry to stand for 30 minutes, the slurry was subjected to filtration, washing with water, drying and pulverization, thereby obtaining the black-brown hematite particles coated with hydroxides of aluminum.

Main production conditions are shown in Table 2, and various properties of the obtained surface-treated black-brown hematite particles are shown in Table 3.

Hematite Particles 5 to 6

The same procedure as defined in the production of the hematite particles 4 above, was conducted except that kind of hematite particles, and kind and amount of additives used in the surface treatment were varied, thereby obtaining surface-treated hematite particles.

Main production conditions are shown in Table 2, and various properties of the obtained surface-treated hematite particles are shown in Table 3.

Meanwhile, as to kind of coating material used in the surface-treatment step, “A” represents hydroxides of aluminum; and “S” represents oxides of silicon.

Organic Blue-based Pigments A to C

As organic blue-based pigments, there were prepared phthalocyanine blue pigments having properties shown in Table 4.

### Examples 3 to 8

### Comparative Examples 1 to 4

The same procedure as defined in Example 1 was conducted except that kind of hematite particles, kind and amount of alkoxysilane or polysiloxanes added in the coating step therewith, linear load and time of edge runner treatment in the coating step, kind and amount of organic blue-based pigment adhered in the pigment-adhering step, and linear load and time of edge runner treatment in the pigment-adhering step, were varied, thereby obtaining non-magnetic composite particles.

Production conditions are shown in Table 5, and various properties of the obtained non-magnetic composite particles are shown in Table 6.

As a result of the observation of electron micrograph, almost no organic blue-based pigment liberated was recognized, so that it was confirmed that a substantially whole amount of the organic blue-based pigment added was adhered on the coating layer composed of the organosilane compounds produced from alkoxysilane or polysiloxanes.

### Production of Black Toner

### Examples 9 to 14

### Comparative Examples 5 to 11

The same procedure as defined in Example 1 was conducted except that kind of non-magnetic composite particles were varied, thereby obtaining a black toner.

Production conditions are shown in Table 7, and various properties of the obtained black toner are shown in Table 8.

TABLE 1

| | |
|---|---|
| Hematite | Properties of hematite particles |

| particles | Kind | Particle shape |
|---|---|---|
| Hematite | Black-brown hematite | Granular |
| particles 1 | particles | |
| | (Mn content: 13.3 wt. %) | |
| Hematite | Black-brown hematite | Granular |
| particles 2 | particles | |
| | (Mn content: 11.6 wt. %) | |
| Hematite | Hematite particles | Granular |
| particles 3 | | |

| | Properties of hematite particles | | |
|---|---|---|---|
| | | | Geometrical |
| | Average | | standard |
| | particle | | deviation |
| Hematite | size | Sphericity | value |
| particles | (μm) | (−) | (−) |
| Hematite | 0.30 | 1.3:1 | 1.48 |
| particles 1 | | | |
| Hematite | 0.16 | 1.2:1 | 1.46 |
| particles 2 | | | |
| Hematite | 0.38 | 1.2:1 | 1.43 |
| particles 3 | | | |

| | Properties of hematitle particles | | |
|---|---|---|---|
| | BET specific | Volume | |
| | surface | resistivity | Fluidity |
| Hematite | area value | value | index |
| particles | (m²/g) | (Ω · cm) | (−) |
| Hematite | 4.0 | 4.6 × 10⁷ | 34 |
| particles 1 | | | |
| Hematite | 7.3 | 6.4 × 10⁷ | 33 |
| particles 2 | | | |
| Hematite | 1.6 | 5.3 × 10⁸ | 33 |
| particles 3 | | | |

Properties of hematite particles

| | Hue | | | Light |
|---|---|---|---|---|
| | L* | a* | b* | resistance |
| Hematite | value | value | value | (ΔE* value) |
| particles | (−) | (−) | (−) | (−) |
| Hematite | 13.2 | 3.2 | 5.9 | 7.2 |
| particles 1 | | | | |
| Hematite | 14.0 | 5.6 | 6.0 | 8.1 |
| particles 2 | | | | |
| Hematite | 25.2 | 15.6 | 11.8 | 6.5 |
| particles 3 | | | | |

TABLE 2

| | | Surface-treating step | | |
|---|---|---|---|---|
| | Kind of | Additives | | |
| Hematite | hematite | | Calculated | Amount |
| particles | particles | Kind | as | (wt. %) |
| Hematite | Hematite | Sodium | Al | 0.5 |
| particles 4 | particles 1 | aluminate | | |
| Hematite | Hematite | Water | SiO₂ | 0.1 |
| particles 5 | particles 2 | glass #3 | | |
| Hematite | Hematite | Aluminum | Al | 1.0 |
| particles 6 | particles 3 | sulfate | | |

| | Surface-treating step | | |
|---|---|---|---|
| | Coating material | | |
| Hematite | | Calculated | Amount |
| particles | Kind | as | (wt. %) |
| Hematite | A | Al | 0.49 |
| particles 4 | | | |
| Hematite | S | Si0₂ | 0.10 |
| particles 5 | | | |
| Hematite | A | Al | 0.98 |
| particles 6 | | | |

TABLE 3

| | Properties of surface-treated | | |
|---|---|---|---|
| | hematite particles | | |
| | | | Geometrical |
| | Average | | standard |
| | particle | | deviation |
| Hematite | size | Sphericity | value |
| particles | (μm) | (−) | (−) |
| Hematite | 0.30 | 1.3:1 | 1.48 |
| particles 4 | | | |
| Hematite | 0.16 | 1.2:1 | 1.46 |
| particles 5 | | | |
| Hematite | 0.38 | 1.2:1 | 1.43 |
| particles 6 | | | |

| | Properties of surface-treated | | |
|---|---|---|---|
| | hematite particles | | |
| | BET specific | Volume | |
| | surface | resistivity | Fluidity |
| Hematite | area value | value | index |
| particles | (m²/g) | (Ω · cm) | (−) |
| Hematite | 4.6 | 6.8 × 10⁷ | 36 |
| particles 4 | | | |
| Hematite | 7.8 | 7.9 × 10⁷ | 35 |
| particles 5 | | | |
| Hematite | 2.2 | 6.8 × 10⁸ | 35 |
| particles 6 | | | |

Properties of surface-treated
hematite particles

| | Hue | | | Light |
|---|---|---|---|---|
| | L* | a* | b* | resistance |
| Hematite | value | value | value | (ΔE* value) |
| particles | (−) | (−) | (−) | (−) |
| Hematite | 13.6 | 3.1 | 5.6 | 6.8 |
| particles 4 | | | | |
| Hematite | 15.3 | 5.9 | 5.7 | 7.7 |
| particles 5 | | | | |
| Hematite | 25.8 | 15.8 | 11.4 | 6.2 |
| particles 6 | | | | |

TABLE 4

| | |
|---|---|
| Organic | |
| blue-based | Properties of organic blue-based pigment |

| pigment | Kind | Particle shape |
|---|---|---|
| Organic | Copper phthalocyanine blue | Granular |
| blue-based | (C.I. Pigment Blue 15:1) | |
| pigment A | | |
| Organic | Copper phthalocyanine blue | Granular |
| blue-based | (C.I. Pigment Blue 15:4) | |
| pigment B | | |
| Organic | Copper phthalocyanine blue | Granular |
| blue-based | (C.I. Pigment Blue 15:2) | |
| pigment C | | |

Properties of organic blue-based pigment

| Organic | Average particle | BET specific surface |
|---|---|---|
| blue-based | size | area value |
| pigment | (μm) | (m²/g) |
| Organic | 0.06 | 71.6 |
| blue-based | | |
| pigment A | | |
| Organic | 0.08 | 56.3 |
| blue-based | | |
| pigment B | | |
| Organic | 0.10 | 45.2 |
| blue-based | | |
| pigment C | | |

Properties of organic blue-based pigment

| | Hue | | | Light |
|---|---|---|---|---|
| Organic | L* | a* | b* | resistance |
| blue-based | value | value | value | (ΔE* value) |
| pigment | (−) | (−) | (−) | (−) |
| Organic | 5.2 | 9.7 | −21.8 | 4.8 |
| blue-based | | | | |
| pigment A | | | | |
| Organic | 4.6 | 11.6 | −25.1 | 2.6 |
| blue-based | | | | |
| pigment B | | | | |
| Organic | 3.9 | 12.1 | −27.8 | 3.7 |
| blue-based | | | | |
| pigment C | | | | |

TABLE 5

Production of non-magnetic
composite particles
Coating step with alkoxysilane
or polysiloxanes
Additives

| Examples | | | Amount |
|---|---|---|---|
| and | Kind of | | added |
| Comparative | hematite | | (part by |
| Examples | particles | Kind | weight) |
| Example 3 | Hematite | Methyl | 2.0 |
| | particles 1 | triethoxysilane | |
| Example 4 | Hematite | Methyl | 1.0 |
| | particles 2 | triethoxysilane | |
| Example 5 | Hematite | Methyl | 1.0 |
| | particles 3 | trimethoxysilane | |
| Example 6 | Hematite | Phenyl | 2.0 |
| | particles 4 | triethoxysilane | |
| Example 7 | Hematite | Phenyl | 1.0 |
| | particles 5 | triethoxysilane | |
| Example 8 | Hematite | Methylhydrogen | 1.0 |
| | particles 6 | polysiloxane | |
| Comparative | Hematite | — | — |
| Example 1 | particles 1 | | |
| Comparative | Hematite | Methyl | 1.0 |
| Example 2 | particles 1 | triethoxysilane | |
| Comparative | Hematite | Methyl | 0.005 |
| Example 3 | particles 1 | triethoxysilane | |
| Comparative | Hematite | Methyl | 1.0 |
| Example 4 | particles 1 | triethoxysilane | |

| | Production of non-magnetic composite | | | |
|---|---|---|---|---|
| | particles | | | |
| | Coating step with alkoxysilane or | | | |
| Examples | polysiloxanes | | | |
| and | Edge runner treatment | | | Coating amount |
| Comparative | Linear load | | Time | (calculated as Si) |
| Examples | (N/cm) | (Kg/cm) | (min.) | (wt. %) |
| Example 3 | 588 | 60 | 20 | 0.30 |
| Example 4 | 588 | 60 | 20 | 0.15 |
| Example 5 | 294 | 30 | 30 | 0.20 |
| Example 6 | 441 | 45 | 30 | 0.27 |
| Example 7 | 588 | 60 | 20 | 0.13 |
| Example 8 | 735 | 75 | 20 | 0.41 |
| Comparative | — | — | — | — |
| Example 1 | | | | |
| Comparative | 588 | 60 | 20 | 0.15 |
| Example 2 | | | | |
| Comparative | 588 | 60 | 20 | 6 × 10⁻⁴ |
| Example 3 | | | | |
| Comparative | 588 | 60 | 20 | 0.15 |
| Example 4 | | | | |

| | Production of non-magentic composite |
|---|---|
| | particles |
| | Adhesion step with organic blue-based |
| Examples | pigment |
| and | Organic blue-based pigment |

| Comparative | | Amount adhered |
|---|---|---|
| Examples | Kind | (part by weight) |
| Example 3 | A | 10.0 |
| Example 4 | B | 15.0 |
| Example 5 | C | 20.0 |
| Example 6 | A | 15.0 |
| Example 7 | B | 12.0 |
| Example 8 | C | 30.0 |
| Comparative | A | 10.0 |
| Example 1 | | |
| Comparative | — | — |
| Example 2 | | |
| Comparative | A | 10.0 |
| Example 3 | | |
| Comparative | A | 0.1 |
| Example 4 | | |

| | Production of non-magnetic composite | | | |
|---|---|---|---|---|
| | particles | | | |
| | Adhesion step with organic blue-based | | | |
| Examples | pigment | | | |
| and | Edge runner treatment | | | Coating amount |
| Comparative | Linear load | | Time | (calculated as C) |
| Examples | (N/cm) | (Kg/cm) | (min.) | (wt. %) |
| Example 3 | 588 | 60 | 30 | 6.01 |
| Example 4 | 588 | 60 | 30 | 8.62 |
| Example 5 | 441 | 45 | 20 | 11.05 |
| Example 6 | 588 | 60 | 30 | 8.59 |
| Example 7 | 441 | 45 | 30 | 7.07 |
| Example 8 | 588 | 60 | 20 | 15.33 |
| Comparative | 588 | 60 | 30 | 6.00 |
| Example 1 | | | | |
| Comparative | — | — | — | — |
| Example 2 | | | | |
| Comparative | 588 | 60 | 30 | 5.97 |
| Example 3 | | | | |
| Comparative | 588 | 60 | 30 | 0.06 |
| Example 4 | | | | |

TABLE 6

| | |
|---|---|
| Examples | Properties of non-magnetic composite |
| and | particles |

| Comparative | Average particle | Sphericity |
|---|---|---|
| Examples | size (μm) | (−) |
| Example 3 | 0.30 | 1.3:1 |
| Example 4 | 0.17 | 1.2:1 |
| Example 5 | 0.39 | 1.2:1 |
| Example 6 | 0.31 | 1.3:1 |
| Example 7 | 0.16 | 1.2:1 |
| Example 8 | 0.39 | 1.2:1 |
| Comparative | 0.30 | 1.3:1 |
| Example 1 | | |
| Comparative | 0.30 | 1.3:1 |
| Example 2 | | |
| Comparative | 0.30 | 1.3:1 |
| Example 3 | | |
| Comparative | 0.30 | 1.3:1 |
| Example 4 | | |

| | Properties of non-magnetic composite | | |
|---|---|---|---|
| | particles | | |
| Examples | Geometrical | BET specific | Volume |
| and | standard | surface area | resistivity |
| Comparative | deviation | value | value |
| Examples | value (−) | (m²/g) | (Ω · cm) |
| Example 3 | 1.48 | 6.8 | 7.8 × 10⁶ |
| Example 4 | 1.46 | 10.2 | 8.4 × 10⁶ |
| Example 5 | 1.43 | 6.1 | 6.4 × 10⁷ |
| Example 6 | 1.48 | 7.5 | 8.2 × 10⁶ |
| Example 7 | 1.46 | 10.9 | 9.8 × 10⁶ |
| Example 8 | 1.43 | 5.4 | 4.9 × 10⁷ |
| Comparative | — | 14.6 | 8.8 × 10⁶ |
| Example 1 | | | |
| Comparative | 1.48 | 4.9 | 2.9 × 10⁷ |
| Example 2 | | | |
| Comparative | — | 12.6 | 8.1 × 10⁶ |
| Example 3 | | | |
| Comparative | — | 7.2 | 3.7 × 10⁷ |
| Example 4 | | | |

Properties of non-magnetic composite
particles

| Examples | | Hue | | |
|---|---|---|---|---|
| and | Fluidity | L* | a* | b* |
| Comparative | index | value | value | value |
| Examples | (−) | (−) | (−) | (−) |
| Example 3 | 50 | 7.8 | −0.6 | −0.8 |
| Example 4 | 48 | 7.4 | −0.5 | −1.2 |
| Example 5 | 47 | 9.8 | −0.2 | 3.6 |
| Example 6 | 53 | 7.2 | −0.5 | −0.9 |
| Example 7 | 50 | 7.8 | −0.4 | −0.1 |
| Example 8 | 50 | 9.3 | −0.3 | 4.3 |
| Comparative | 37 | 12.2 | 2.3 | 2.4 |
| Example 1 | | | | |
| Comparative | 35 | 13.5 | 3.4 | 5.5 |
| Example 2 | | | | |
| Comparative | 38 | 12.0 | 2.1 | 2.1 |
| Example 3 | | | | |
| Comparative | 36 | 13.1 | 3.1 | 5.3 |
| Example 4 | | | | |

| | Properties of non-magnetic composite |
|---|---|
| Examples | particles |

| and | Light resistance | Desorption percentage |
|---|---|---|
| Comparative | (ΔE* value) | of organic blue-based |
| Examples | (−) | pigment (%) |
| Example 3 | 3.5 | 5.5 |
| Example 4 | 3.7 | 6.1 |
| Example 5 | 3.0 | 7.3 |
| Example 6 | 2.4 | 3.8 |
| Example 7 | 2.7 | 2.7 |
| Example 8 | 1.8 | 3.9 |
| Comparative | 7.0 | 66.4 |
| Example 1 | | |
| Comparative | 6.7 | — |
| Example 2 | | |
| Comparative | 6.9 | 45.9 |
| Example 3 | | |
| Comparative | 6.6 | — |
| Example 4 | | |

TABLE 7

| | |
|---|---|
| Examples | Production of black toner |
| and | Non-magnetic composite particles |

| Comparative | | Amount blended |
|---|---|---|
| Examples | Kind | (part by weight) |
| Example 9 | Example 3 | 15 |
| Example 10 | Example 4 | 15 |
| Example 11 | Example 5 | 15 |
| Example 12 | Example 6 | 15 |
| Example 13 | Example 7 | 15 |
| Example 14 | Example 8 | 15 |
| Comparative | Hematite particles 1 | 15 |
| Example 5 | | |
| Comparative | Hematite particles 2 | 15 |
| Example 6 | | |
| Comparative | Hematite particles 3 | 15 |
| Example 7 | | |
| Comparative | Comparative Example 1 | 15 |
| Example 8 | | |
| Comparative | Comparative Example 2 | 15 |
| Example 9 | | |
| Comparative | Comparative Example 3 | 15 |
| Example 10 | | |
| Comparative | Comparative Example 4 | 15 |
| Example 11 | | |

| | |
|---|---|
| Examples | Production of black toner |
| and | Binder resin |

| Comparative | | Amount blended |
|---|---|---|
| Examples | Kind | (part by weight) |
| Example 9 | Styrene-acrylic | 85 |
| | copolymer resin | |
| Example 10 | Styrene-acrylic | 85 |
| | copolymer resin | |
| Example 11 | Styrene-acrylic | 85 |
| | copolymer resin | |
| Example 12 | Styrene-acrylic | 85 |
| | copolymer resin | |
| Example 13 | Styrene-acrylic | 85 |
| | copolymer resin | |
| Example 14 | Styrene-acrylic | 85 |
| | copolymer resin | |
| Comparative | Styrene-acrylic | 85 |
| Example 5 | copolymer resin | |
| Comparative | Styrene-acrylic | 85 |
| Example 6 | copolymer resin | |
| Comparative | Styrene-acrylic | 85 |
| Example 7 | copolymer resin | |
| Comparative | Styrene-acrylic | 85 |
| Example 8 | copolymer resin | |
| Comparative | Styrene-acrylic | 85 |
| Example 9 | copolymer resin | |
| Comparative | Styrene-acrylic | 85 |
| Example 10 | copolymer resin | |
| Comparative | Styrene-acrylic | 85 |
| Example 11 | copolymer resin | |

TABLE 8

| | |
|---|---|
| Examples | |
| and | Properties of black toner |

| Comparative | Average particle | Dispersibility |
|---|---|---|
| Examples | size (μm) | (−) |
| Example 9 | 10.1 | 5 |
| Example 10 | 9.9 | 5 |
| Example 11 | 10.0 | 5 |
| Example 12 | 10.2 | 5 |
| Example 13 | 9.9 | 5 |
| Example 14 | 10.0 | 5 |
| Comparative | 9.8 | 3 |
| Example 5 | | |
| Comparative | 9.9 | 3 |
| Example 6 | | |
| Comparative | 9.6 | 3 |
| Example 7 | | |
| Comparative | 10.1 | 3 |
| Example 8 | | |
| Comparative | 10.3 | 1 |
| Example 9 | | |
| Comparative | 10.1 | 2 |
| Example 10 | | |
| Comparative | 9.6 | 1 |
| Example 11 | | |

| | |
|---|---|
| Examples | |
| and | Properties of black toner |

| Comparative | Fluidity index | Volume resistivity |
|---|---|---|
| Examples | (−) | value (Ω · cm) |
| Example 9 | 79 | 3.6 × 10¹⁴ |
| Example 10 | 78 | 4.1 × 10¹⁴ |
| Example 11 | 76 | 8.3 × 10¹⁴ |
| Example 12 | 83 | 2.9 × 10¹⁴ |
| Example 13 | 81 | 6.1 × 10¹⁴ |
| Example 14 | 80 | 8.1 × 10¹⁴ |
| Comparative | 51 | 3.8 × 10¹² |
| Example 5 | | |
| Comparative | 48 | 2.9 × 10¹² |
| Example 6 | | |
| Comparative | 46 | 9.1 × 10¹² |
| Example 7 | | |
| Comparative | 57 | 2.2 × 10¹² |
| Example 8 | | |
| Comparative | 52 | 4.6 × 10¹² |
| Example 9 | | |
| Comparative | 59 | 1.8 × 10¹² |
| Example 10 | | |
| Comparative | 53 | 2.6 × 10¹² |
| Example 11 | | |

Properties of black toner

| Examples | Hue | | | Light |
|---|---|---|---|---|
| and | L* | a* | b* | resistance |
| Comparative | value | value | value | (ΔE* value) |
| Examples | (−) | (−) | (−) | (−) |
| Example 9 | 8.3 | −0.5 | −0.5 | 3.0 |
| Example 10 | 7.8 | −0.4 | −0.9 | 3.4 |
| Example 11 | 10.0 | −0.2 | 1.2 | 2.6 |
| Example 12 | 7.6 | −0.4 | −0.6 | 2.0 |
| Example 13 | 8.2 | −0.4 | 0.2 | 2.2 |
| Example 14 | 9.7 | −0.2 | 2.8 | 1.5 |
| Comparative | 13.4 | 3.4 | 3.7 | 6.8 |
| Example 5 | | | | |
| Comparative | 14.3 | 5.9 | 4.2 | 7.5 |
| Example 6 | | | | |
| Comparative | 25.5 | 16.2 | 10.6 | 6.1 |
| Example 7 | | | | |
| Comparative | 12.8 | 2.6 | 0.8 | 6.6 |
| Example 8 | | | | |
| Comparative | 13.6 | 5.8 | 3.1 | 6.4 |
| Example 9 | | | | |
| Comparative | 12.7 | 2.4 | 1.1 | 6.5 |
| Example 10 | | | | |
| Comparative | 13.5 | 5.7 | 2.7 | 6.1 |
| Example 11 | | | | |

What is claimed is:

1. Non-magnetic composite particles having an average particle diameter of 0.06 to 1.0 μm, comprising:
hematite particles,
a coating formed on surface of said hematite particles, comprising at least one organosilicon compound selected from the group consisting of:
(1) organosilane compounds obtainable from alkoxysilane compounds, and
(2) polysiloxanes or modified polysiloxanes, and
an organic blue-based pigment coat formed on said coating layer comprising said organosilicon compound, in an amount of from 1 to 50 parts by weight based on 100 parts by weight of said hematite particles.

2. Non-magnetic composite particles according to claim 1, wherein said hematite particles have:
a coating formed on the surface of said hematite particle, comprising at least one organosilicon compound selected from the group consisting of:
(1) organosilane compounds obtainable from alkoxysilane compounds, and
(2) polysiloxanes or modified polysiloxanes, and
a carbon black coat formed on at least a part of the surface of said coating layer comprising said organosilicon compound, in an amount of 1 to 30 parts by weight based on 100 parts by weight of the said hematite particles.

3. Non-magnetic composite particles according to claim 1, wherein said hematite particles have a coat formed on at least a part of the surface of said hematite particle and comprises at least one compound selected from the group consisting of hydroxides of aluminum, oxides of aluminum, hydroxides of silicon and oxides of silicon in an amount of 0.01 to 50% by weight, calculated as Al or SiO₂, based on the total weight of the hematite particles coated.

4. Non-magnetic composite particles according to claim 1 or 2, wherein said modified polysiloxanes are compounds selected from the group consisting of:
(A) polysiloxanes modified with at least one compound selected from the group consisting of polyethers, polyesters and epoxy compounds, and
(B) polysiloxanes whose molecular terminal is modified with at least one group selected from the group consisting of carboxylic acid groups, alcohol groups and a hydroxyl group.

5. Non-magnetic composite particles according to claim 1 or 2, wherein said alkoxysilane compound is represented by the general formula (I):
R¹ₐSiX₄₋ₐ (I)
wherein R¹ is C₆H₅—, (CH₃)₂CHCH₂— or n—C_{b}H_{2b+1}— (wherein b is an integer of 1 to 18); X is CH₃O— or C₂H₅O—; and a is an integer of 0 to 3.

6. Non-magnetic composite particles according to claim 5, wherein said alkoxysilane compound is methyltriethoxysilane, dimethyldiethoxysilane, phenyltriethoxysilane, diphenyldiethoxysilane, methyltrimethoxysilane, dimethyldimethoxysilane, phenyltrimethoxysilane, diphenyldimethoxysilane, isobutyltrimethoxysilane or decyltrimethoxysilane.

7. Non-magnetic composite particles according to claim 1 or 2, wherein said polysiloxanes are represented by the general formula (II): 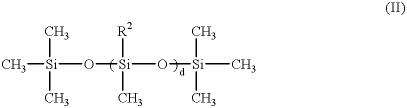
wherein R² is H— or CH₃—, and d is an integer of 15 to 450.

8. Non-magnetic composite particles according to claim 4, wherein said polysiloxanes modified with at least one compound selected from the group consisting of polyethers, polyesters and epoxy compounds are represented by the general formula (III), (IV) or (V): 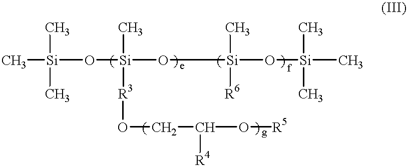
wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300; 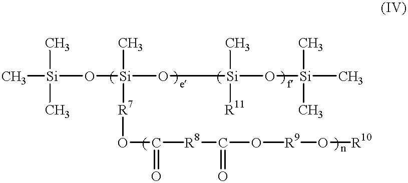
wherein R⁷, R⁸ and R⁹ are —(—CH2—)_{q}— and may be the same or different; R¹⁰ is —OH, —COOH, —CH═CH₂, —C(CH₃)═CH₂ or —(—CH₂—)ᵣ—CH₃; R¹¹ is —(—CH2—)ₛ—CH3; n and q are an integer of 1 to 15; r and s are an integer of 0 to 15; e′ is an integer of 1 to 50; and f′ is an integer of 1 to 300; or 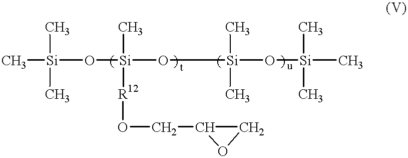
wherein R¹² is —(—CH₂—)ᵥ—; v is an integer of 1 to 15; t is an integer of 1 to 50; and u is an integer of 1 to 300.

9. Non-magnetic composite particles according to claim 4, wherein said polysiloxanes whose molecular terminal is modified with at least one group selected from the group consisting of carboxylic acid groups, alcohol groups and a hydroxyl group are represented by the general formula (VI): 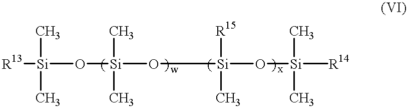
wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

10. Non-magnetic composite particles according to claim 1 or 2, wherein the amount of said coating organosilicon compounds is 0.02 to 5.0% by weight, calculated as Si, based on the total weight of the organosilicon compounds and said hematite particles.

11. Non-magnetic composite particles according to claim 1, wherein said non-magnetic composite particles have a BET specific surface area value of 1.0 to 200 m²/g, a geometrical standard deviation of the particle size of 1.01 to 2.0, a fluidity index of 44 to 80, and a volume resistivity value of not less than 5.0×10⁵ Ω·cm.

12. Non-magnetic composite particles according to claim 1, wherein said non-magnetic composite particles have a L* value of 2.0 to 15.0, an a* value of −2.0 to 0.0, a b* value thereof of −3.0 to 5.5, and a light resistance (ΔE* value) of not more than 5.0.

13. Non-magnetic composite particles according to claim 1, wherein said organic blue-based pigment is a phthalocyanine-based pigment and an alkali blue pigment.

14. A process for producing said non-magnetic composite particles defined in claim 1, which process comprises:
mixing hematite particles together with at least one compound selected from the group consisting of:
(1) alkoxysilane compounds, and
(2) polysiloxanes or modified polysiloxanes, by using an apparatus capable of applying a shear force to the hematite particles, thereby coating the surface of said hematite particle with the said compounds;
mixing the obtained hematite particles coated with the said compounds and an organic blue-based pigments in an amount of 1 to 50 parts by weight based on 100 parts by weight of the hematite particles by using an apparatus capable of applying a shear force to the hematite particles coated with said compound, thereby forming an organic blue-based pigments coat on the surface of a coating layer comprising the organosilicon compounds.

15. A process for producing non-magnetic composite particles according to claim 14, wherein said hematite particles have:
a coating formed on the surface of said hematite particles, comprising at least one organosilicon compound selected from the group consisting of:
(1) organosilane compounds obtainable from alkoxysilane compounds, and
(2) polysiloxanes or modified polysiloxanes, and
a carbon black coat formed on at least a part of the surface of said coating layer comprising said organosilicon compound, in an amount of 1 to 30 parts by weight based on 100 parts by weight of the said hematite particles.

16. A process for producing non-magnetic composite particles according to claim 14, wherein said hematite particles are coated with at least one compound selected from the group consisting of hydroxides of aluminum, oxides of aluminum, hydroxides of silicon and oxides of silicon.

17. Black toner comprising:
a binder resin, and
non-magnetic composite particles having an average particle diameter of 0.06 to 1.0 μm, comprising:
hematite particles,
a coating formed on surface of said hematite particles, comprising at least one organosilicon compound selected from the group consisting of:
(1) organosilane compounds obtainable from alkoxysilane compounds, and
(2) polysiloxanes or modified polysiloxanes, and
an organic blue-based pigment coat formed on said coating layer comprising said organosilicon compound, in an amount of from 1 to 50 parts by weight based on 100 parts by weight of said hematite particles.

18. Black toner according to claim 17, wherein the amount of the binder resin is 50 to 3500 parts by weight based on 100 parts by weight of the non-magnetic composite particles.

19. Black toner according to claim 17, which further comprises an average particle size of 3 to 25 μm.

20. Black toner according to claim 17, which further comprises a flowability index of 70 to 100 and a volume resistivity of not less than 1.0×10¹³ Ω·cm.

21. Black toner according to claim 17, which further comprises a blackness (L* value) of 2.0 to 15.0, an a* value of −2.0 to 0.0, a b* value of −3.0 to 5.5 and a light resistance (>B* value) of not more than 5.0.

22. Black toner according to claim 17, wherein said hematite particles have:
a coating formed on the surface of the said hematite particle, comprising at least one organosilicon compound selected from the group consisting of:
(1) organosilane compounds obtainable from alkoxysilane compounds, and
(2) polysiloxanes or modified polysiloxanes, and
a carbon black coat formed on at least a part of the surface of the said coating layer comprising the said organosilicon compound, in an amount of 1 to 30 parts by weight based on 100 parts by weight of the said hematite particles.

23. Black toner according to claim 17, wherein said hematite particles are particles having a coat which is formed on at least a part of the surface of said hematite particles and which comprises at least one compound selected from the group consisting of hydroxides of aluminum, oxides of aluminum, hydroxides of silicon and oxides of silicon in an amount of 0.01 to 50% by weight, calculated as Al or SiO₂, based on the total weight of the hematite particles coated.

24. Black toner according to claim 17 or 22, wherein the amount of said coating organosilicon compounds is 0.02 to 5.0% by weight, calculated as Si, based on the total weight of the organosilicon compounds and said hematite particles.

25. Non-magnetic composite particles comprising:
hematite particles,
a coating formed on surface of said hematite particles, comprising at least one organosilicon compound selected from the group consisting of:
(1) organosilane compounds obtainable from alkoxysilane compounds, and
(2) polysiloxanes or modified polysiloxanes, and
an organic blue-based pigment coat formed on said coating layer comprising said organosilicon compound, in an amount of from 1 to 50 parts by weight based on 100 parts by weight of said hematite particles; and
having an average particle diameter of 0.06 to 1.0 μm, a BET specific surface area value of 1.0 to 200 m²/g, a geometrical standard deviation of the particle size of 1.01 to 2.0, a L* value of 2.0 to 15.0, an a* value of −2.0 to 0.0, a b* value of −3.0 to 5.5.

26. Black toner comprising:
a binder resin, and
non-magnetic composite particles having an average particle diameter of 0.06 to 1.0 μm, comprising:
hematite particles,
a coating formed on surface of said hematite particles, comprising at least one organosilicon compound selected from the group consisting of:
(1) organosilane compounds obtainable from alkoxysilane compounds, and
(2) polysiloxanes or modified polysiloxanes, and
an organic blue-based pigment coat formed on said coating layer comprising said organosilicon compound, in an amount of from 1 to 50 parts by weight based on 100 parts by weight of said hematite particles; and
having an average particle size of 3 to 25 μm, a flowability index of 70 to 100, a volume resistivity of not less than 1.0×10¹³ Ω·cm, a blackness (L* value) of 2.0 to 15.0, an a* value of −2.0 to 0.0, a b* value of −3.0 to 5.5, a light resistance (ΔE* value) of not more than 5.0.
